(19) United States
(12) Patent Application Publication
(10) Pub. No.: US 2026/0178077 A1
(43) Pub. Date: Jun. 25, 2026

(54) DETECTION DEVICE AND WEARABLE DEVICE

(71) Applicant: Japan Display Inc., Tokyo (JP)

(72) Inventor: Yuta HAGA, Tokyo (JP)

(21) Appl. No.: 19/428,709

(22) Filed: Dec. 22, 2025

Related U.S. Application Data
(63) Continuation of application No. PCT/JP2024/019181, filed on May 24, 2024.

(30) Foreign Application Priority Data
Jun. 29, 2023 (JP) 2023-107049

(51) Int. Cl. G06F 1/16; G01J 1/16; G06F 3/01

(52) U.S. Cl. CPC G06F 1/163; G01J 1/16; G06F 1/1684; G06F 3/014

(57) ABSTRACT

According to an aspect, a detection device includes: a sensor area including pixels; a light source; and a detection circuit. The detection circuit is configured to: generate first frequency domain data for each pixel; set a highest strength of signal strengths of the first frequency domain data, as a first signal strength of each pixel; set an area in the sensor area where the first signal strength is equal to or higher than a predetermined value, as a first area; generate second frequency domain data; set a highest strength of the signal strengths of the second frequency domain data, as a second signal strength of each pixel; set an area where the second signal strength is equal to or higher than the predetermined value, as a second area; acquire biometric information based on the first or second frequency domain data depending on the size of the second area.

### CROSS-REFERENCE TO RELATED APPLICATION

This application claims the benefit of priority from Japanese Patent Application No. 2023-107049 filed on Jun. 29, 2023 and International Patent Application No. PCT/JP2024/019181 filed on May 24, 2024, the entire contents of which are incorporated herein by reference.

### BACKGROUND

### 1. Technical Field

What is disclosed herein relates to a detection device and a wearable device.

### 2. Description of the Related Art

United States Patent Application Publication No. 2018/0012069 describes an optical sensor in which a plurality of photoelectric conversion elements such as photodiodes are arranged on a semiconductor substrate. In the optical sensor, signals output from the photoelectric conversion elements change with an amount of irradiating light, thereby enabling detection of biometric information.

When a detection device is worn on a human body to acquire pulse waves, periodic body motion noise generated by walking or the like may be erroneously determined as the pulse waves.

For the foregoing reasons, there is a need for a detection device and a wearable device that are capable of reducing the periodic body motion noise when acquiring the biometric information.

### SUMMARY

According to an aspect, a detection device includes: a sensor area including a plurality of pixels arranged in a planar configuration; a light source configured to emit light to the sensor area; and a detection circuit configured to acquire periodically varying biometric information based on data acquired from the sensor area. The detection circuit is configured to: generate first frequency domain data for each of the pixels by converting detection values of the pixel acquired in chronological order into signal strengths for respective frequencies; set a highest strength of the signal strengths corresponding to the respective frequencies of the first frequency domain data, as a first signal strength of each of the pixels; set an area in the sensor area where the first signal strength is equal to or higher than a predetermined value, as a first area; generate second frequency domain data in which a predetermined frequency range of the first frequency domain data of all the pixels in the first area is masked, based on the first frequency domain data of the pixels at an outer periphery of the first area; set a highest strength of the signal strengths corresponding to the respective frequencies of the second frequency domain data, as a second signal strength of each of the pixels; set an area in the sensor area where the second signal strength is equal to or higher than the predetermined value, as a second area; acquire the biometric information based on the second frequency domain data when a size of the second area is equal to or larger than a predetermined value; and acquire the biometric information based on the first frequency domain data when the size of the second area is smaller than the predetermined value.

According to an aspect, a wearable device includes the detection device and has a ring shape wearable on a human body.

### BRIEF DESCRIPTION OF THE DRAWINGS

FIG. 1 is a plan view illustrating a detection device according to an embodiment of the present disclosure;

FIG. 2 is a block diagram illustrating a configuration example of the detection device according to the embodiment;

FIG. 3 is a circuit diagram illustrating the detection device according to the embodiment;

FIG. 4 is a circuit diagram illustrating a plurality of pixels;

FIG. 5 is a schematic partial sectional view of an optical sensor according to the embodiment;

FIG. 6 is a timing waveform diagram illustrating an operation example in one frame period of the detection device according to the embodiment;

FIG. 7 is a timing waveform diagram illustrating an operation example in a reset period in FIG. 6;

FIG. 8 is a timing waveform diagram illustrating an operation example in a readout period in FIG. 6;

FIG. 9 is a timing waveform diagram illustrating an operation example in a drive period of one gate line included in the readout period in FIG. 6;

FIG. 10 is an explanatory diagram for explaining a relation between driving of a sensor area and lighting operations of light sources in the detection device according to the embodiment;

FIG. 11 is a schematic view illustrating a first application example of the detection device according to the embodiment;

FIG. 12 is a schematic view illustrating a second application example of the detection device according to the embodiment;

FIG. 13 is a flowchart illustrating an example of a detection process in the detection device according to the embodiment;

FIG. 14 is a sub-flowchart illustrating an example of a Raw data acquisition process;

FIG. 15 is a table illustrating detection values of each of the pixels in a detection area for F frames;

FIG. 16 is a sub-flowchart illustrating an example of a first image generation process;

FIG. 17 is a sub-flowchart illustrating an example of a first signal strength extraction process;

FIG. 18 is a diagram illustrating an example of time domain data;

FIG. 19 is a diagram illustrating an example of frequency domain data;

FIG. 20 is a sub-flowchart illustrating an example of a binarization process in the first image generation process;

FIG. 21 is a diagram illustrating a specific example of an illustrative image obtained by converting first binary values of the respective pixels into an image;

FIG. 22 is a sub-flowchart illustrating an example of a filter generation process;

FIG. 23 is a sub-flowchart illustrating an example of an edge extraction process;

FIG. 24 is a diagram illustrating a specific example of an illustrative image obtained by converting second binary values of the respective pixels into an image;

FIG. 25 is a sub-flowchart illustrating an example of an averaging process;

FIG. 26 is a diagram illustrating an example of an average of signal strengths of the multiple pixels in the illustrative image illustrated in FIG. 24;

FIG. 27 is a diagram illustrating an example of a filter value;

FIG. 28 is a sub-flowchart illustrating an example of a second image generation process;

FIG. 29 is a sub-flowchart illustrating an example of a second signal strength calculation process;

FIG. 30 is a diagram illustrating an example of second frequency domain data;

FIG. 31 is a schematic diagram illustrating a positional relation between a pulse wave component detection area and a body motion noise component detection area in the sensor area;

FIG. 32 is a sub-flowchart illustrating an example of the binarization process in the second image generation process;

FIG. 33 is a diagram illustrating a specific example of an illustrative image obtained by converting third binary values of the respective pixels into an image;

FIG. 34 is a sub-flowchart illustrating an example of a pulse wave generation process;

FIG. 35 is a sub-flowchart illustrating an example of a first pulse wave generation process;

FIG. 36 is a sub-flowchart illustrating an example of a second pulse wave generation process;

FIG. 37 is a diagram illustrating an example of first frequency domain data when the time domain data does not contain periodic noise components such as the body motion noise; and

FIG. 38 is a diagram illustrating an example of the second frequency domain data when the time domain data does not contain the periodic noise components such as the body motion noise.

### DETAILED DESCRIPTION

The following describes a mode (embodiment) for carrying out the present disclosure in detail with reference to the drawings. The present disclosure is not limited to the description of the embodiment given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present specification and the drawings, and detailed description thereof may not be repeated where appropriate.

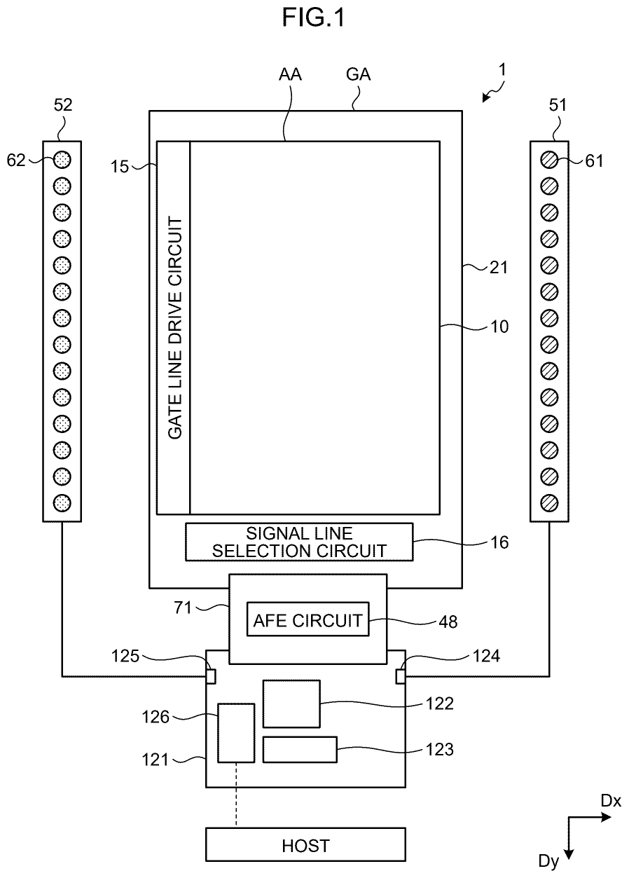

FIG. 1 is a plan view illustrating a detection device according to an embodiment of the present disclosure. In the present disclosure, a detection device 1 is configured as a detection device that is worn on, for example, a finger, a thumb, a wrist, or the like of a subject person, and detects pulse waves of the subject person as biometric information.

As illustrated in FIG. 1, the detection device 1 includes a sensor base member 21, a sensor area 10, a gate line drive circuit 15, a signal line selection circuit 16, an analog front-end (AFE) circuit 48, a control circuit 122, a power supply circuit 123, a first light source 61, and a second light source 62.

The detection device 1 is electrically coupled to a host. The host is, for example, a higher-level control device for an apparatus (not illustrated) to which the detection device 1 is applied. The detection device 1 according to the embodiment transmits acquired biometric information to the host via an output circuit 126.

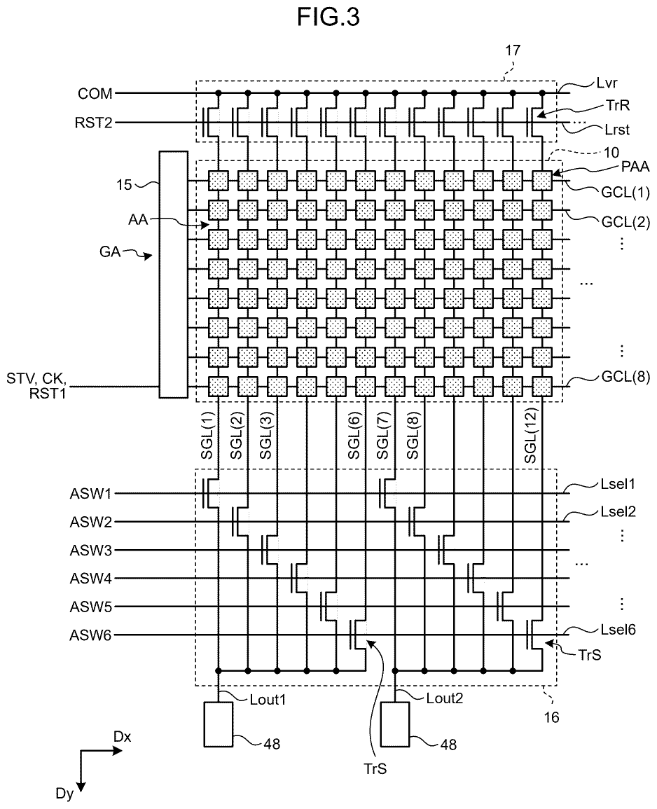

The sensor base member 21 is electrically coupled to a control substrate 121 via a flexible printed circuit board 71. The flexible printed circuit board 71 is provided with the AFE circuit 48. The control substrate 121 is provided with the control circuit 122, the power supply circuit 123, and the output circuit 126. As illustrated in FIG. 3 described later, the AFE circuit 48 is circuitry including a plurality of AFE circuits each of which is provided for a plurality signal lines. In the following descriptions, each of the plurality of AFE circuits included in the AFE circuit 48 as entire circuitry is given the same reference sign “48” and is referred to as the “AFE circuit 48” in some cases.

The control circuit 122 is, for example, a control integrated circuit (IC) that outputs logic control signals. The control circuit 122 may be, for example, a programmable logic device (PLD) such as a field-programmable gate array (FPGA).

The control circuit 122 supplies control signals to the sensor area 10, the gate line drive circuit 15, and the signal line selection circuit 16 to control detection operations in the sensor area 10. The control circuit 122 also supplies control signals to the first and the second light sources 61 and 62 to control lighting or non-lighting of the first and the second light sources 61 and 62.

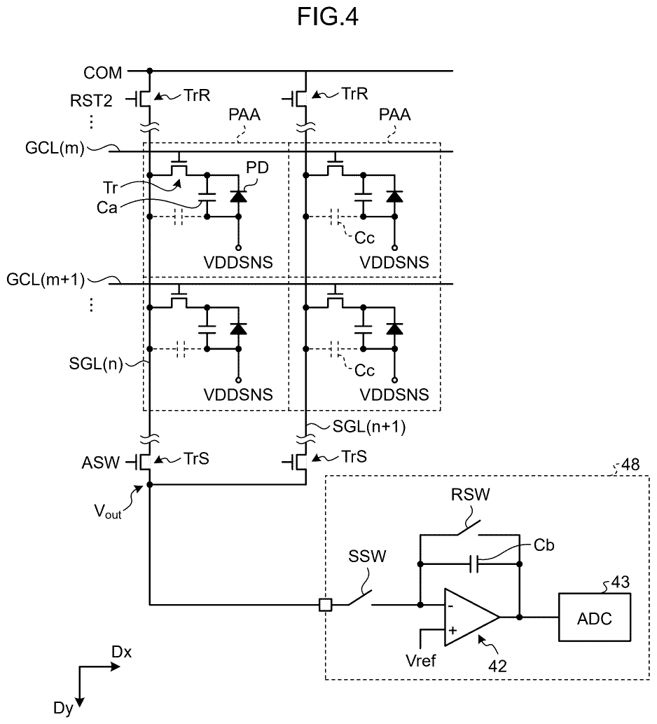

The power supply circuit 123 supplies voltage signals such as a sensor power supply potential VDDSNS (refer to FIG. 4) to the sensor area 10, the gate line drive circuit 15, and the signal line selection circuit 16. The power supply circuit 123 supplies a power supply voltage to the first and the second light sources 61 and 62.

The output circuit 126 is, for example, a Universal Serial Bus (USB) controller IC, and controls communication between the control circuit 122 and the host.

The sensor base member 21 has a detection area AA and a peripheral area GA. The detection area AA is an area where a plurality of optical sensors PD (refer to FIG. 4) included in the sensor area 10 are provided in a matrix having a row-column configuration. The peripheral area GA is an area between the outer perimeter of the detection area AA and the ends of the sensor base member 21 and is an area not provided with the optical sensors PD.

The gate line drive circuit 15 and the signal line selection circuit 16 are provided in the peripheral area GA. Specifically, the gate line drive circuit 15 is provided in an area extending along a second direction Dy in the peripheral area GA. The signal line selection circuit 16 is provided in an area extending along a first direction Dx in the peripheral area GA and is provided between the sensor area 10 and the AFE circuit 48.

The first direction Dx is one direction in a plane parallel to the sensor base member 21. The second direction Dy is one direction in the plane parallel to the sensor base member 21, and is a direction orthogonal to the first direction Dx. The second direction Dy may non-orthogonally intersect the first direction Dx. A third direction Dz is a direction orthogonal to the first direction Dx and the second direction Dy, and is a direction normal to the sensor base member 21.

A plurality of the first light sources 61 are provided on a first light source base member 51, and arranged along the second direction Dy. A plurality of the second light sources 62 are provided on a second light source base member 52, and arranged along the second direction Dy. The first light source base member 51 and the second light source base member 52 are electrically coupled to the control circuit 122 and the power supply circuit 123, through respective terminals 124 and 125 provided on the control substrate 121.

For example, inorganic light-emitting diodes (LEDs) or organic electroluminescent (EL) diodes (organic light-emitting diodes (OLEDs)) are used as the first and the second light sources 61 and 62.

The first and the second light sources 61 and 62 emit at least one of visible light, near-infrared light, and infrared light. The first and the second light sources 61 and 62 may emit light rays having different wavelengths from each other, or may emit light rays having the same wavelength. Specifically, for example, in a configuration with at least the first light sources 61 (or the second light sources 62), first light emitted by the first light sources 61 (or the second light sources 62) may be red light or infrared light, or may be blue light or green light. Alternatively, for example, in a configuration with the first and the second light sources 61 and 62, the first light emitted by the first light sources 61 may be red light, and the second light emitted by the second light sources 62 may be infrared light. The present disclosure is not limited by the emission colors of the first and the second light sources 61 and 62.

In the present disclosure, the light emitted by the first and the second light sources 61 and 62 is, for example, reflected by or transmitted through a surface or inside of the finger, the thumb, the wrist, or the like of the subject person, and enters the sensor area 10. As a result, the sensor area 10 can detect the pulse waves of the subject person.

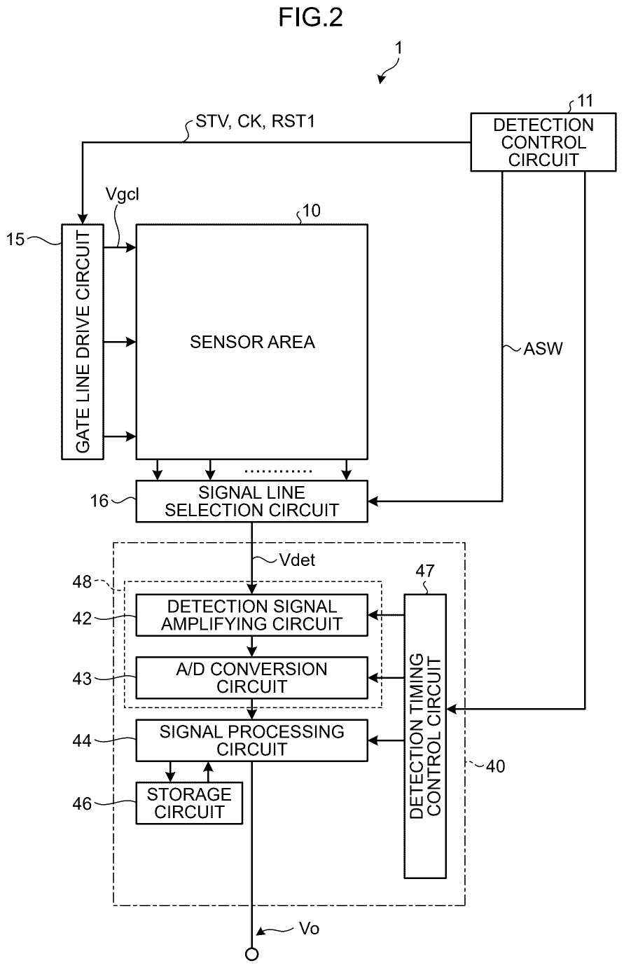

FIG. 2 is a block diagram illustrating a configuration example of the detection device according to the embodiment. As illustrated in FIG. 2, the detection device 1 further includes a detection control circuit 11 and a detection circuit 40.

The sensor area 10 includes the optical sensors PD. Each of the optical sensors PD included in the sensor area 10 is an organic photodiode (OPD), and outputs an electrical signal corresponding to light emitted thereto as a detection signal Vdet to the signal line selection circuit 16. The sensor area 10 performs detection in response to a gate drive signal Vgcl supplied from the gate line drive circuit 15.

The detection control circuit 11 is a circuit that supplies respective control signals to the gate line drive circuit 15, the signal line selection circuit 16, and the detection circuit 40 to control operations of these circuits. The detection control circuit 11 supplies various control signals such as a start signal STV, a clock signal CK, and a reset signal RST1 to the gate line drive circuit 15. The detection control circuit 11 also supplies various control signals such as a selection signal ASW to the signal line selection circuit 16. The detection control circuit 11 also supplies various control signals to the first and the second light sources 61 and 62 to control the lighting and the non-lighting of each group of the first and the second light sources 61 and 62.

The gate line drive circuit 15 is a circuit that drives a plurality of gate lines GCL (refer to FIG. 3) based on various control signals. The gate line drive circuit 15 sequentially or simultaneously selects the gate lines GCL and supplies the gate drive signal Vgcl to the selected gate lines GCL. By this operation, the gate line drive circuit 15 selects the optical sensors PD coupled to the gate lines GCL.

The signal line selection circuit 16 is a switch circuit that sequentially or simultaneously selects a plurality of signal lines SGL (refer to FIG. 3). The signal line selection circuit 16 is a multiplexer, for example. The signal line selection circuit 16 electrically couples the selected signal lines SGL to the AFE circuit 48 based on the selection signal ASW supplied from the detection control circuit 11. Through this operation, the signal line selection circuit 16 outputs the detection signals Vdet of the optical sensors PD to the detection circuit 40.

The detection circuit 40 includes the AFE circuit 48, a signal processing circuit 44, a storage circuit 46, and a detection timing control circuit 47. The detection timing control circuit 47 controls the AFE circuit 48 and the signal processing circuit 44 to operate synchronously based on the control signal supplied from the detection control circuit 11.

The AFE circuit 48 detects the detection signals of the optical sensors PD output from the sensor area 10 in chronological order. The AFE circuit 48 is an analog front-end IC, for example.

The AFE circuit 48 is a signal processing circuit having functions of at least a detection signal amplifying circuit 42 and an analog-to-digital (A/D) conversion circuit 43. The detection signal amplifying circuit 42 amplifies the detection signals Vdet. The A/D conversion circuit 43 converts the analog signals output from the detection signal amplifying circuit 42 into digital signals at a predetermined sampling cycle.

In the present disclosure, the control circuit 122 includes the signal processing circuit 44 and the storage circuit 46.

The signal processing circuit 44 acquires the pulse waves of the subject person based on the detection values of the optical sensors PD output from the AFE circuit 48.

The storage circuit 46 temporarily stores therein the signals processed by the signal processing circuit 44. The storage circuit 46 may, in an aspect, include a random-access memory (RAN), a read-only memory (ROM), an electrically erasable programmable read-only memory (EEPROM), and the like. The storage circuit 46 may be a register circuit or the like.

The following describes a circuit configuration example of the detection device 1. FIG. 3 is a circuit diagram illustrating the detection device according to the embodiment. As illustrated in FIG. 3, the sensor area 10 includes a plurality of pixels PAA arranged in a planar configuration.

Specifically, the pixels PAA are arranged, for example, in the first direction Dx and the second direction Dy in a matrix having a row-column configuration. The pixels PAA are not limited to this arrangement, and may be, in an aspect, arranged in a staggered manner in the detection area AA.

Each of the pixels PAA is provided with the optical sensor PD. Each of the optical sensors PD outputs an electrical signal (potential) corresponding to the light emitted thereto.

The gate lines GCL extend in the first direction Dx and are each coupled to the pixels PAA arranged in the first direction Dx. A plurality of gate lines GCL(1), GCL(2), . . . , GCL(8) are arranged in the second direction Dy and are each coupled to the gate line drive circuit 15. In the following description, the gate lines GCL(1), GCL(2), . . . , GCL(8) will each be simply referred to as the gate line GCL when they need not be distinguished from one another. To facilitate understanding of the description, FIG. 3 illustrates eight gate lines GCL. However, this is merely an example, and M gate lines GCL may be arranged (where M is a natural number, such as 256).

The signal lines SGL extend in the second direction Dy and are each coupled to the optical sensors PD of the pixels PAA arranged in the second direction Dy. A plurality of signal lines SGL(1), SGL(2), . . . , SGL(12) are arranged in the first direction Dx, and are each coupled to the signal line selection circuit 16 and a reset circuit 17. In the following description, the signal lines SGL(1), SGL(2), . . . , SGL(12) will each be simply referred to as the signal line SGL when they need not be distinguished from one another.

To facilitate understanding of the description, 12 signal lines SGL are illustrated. However, this is merely an example, and N signal lines SGL may be arranged (where N is a natural number, such as 252). In FIG. 3, the sensor area 10 is provided between the signal line selection circuit 16 and the reset circuit 17. The signal line selection circuit 16 and the reset circuit 17 are not limited to being provided in this way, and may be coupled to ends of the signal lines SGL on the same side.

The gate line drive circuit 15 receives the various control signals such as the start signal STV, the clock signal CK, and the reset signal RST1 from the control circuit 122 (refer to FIG. 1). The gate line drive circuit 15 sequentially selects the gate lines GCL(1), GCL(2), . . . , GCL(8) in a time-division manner based on the various control signals. The gate line drive circuit 15 supplies the gate drive signal Vgcl to the selected one of the gate lines GCL. This operation supplies the gate drive signal Vgcl to a plurality of first switching elements Tr coupled to the gate line GCL, and thus selects the pixels PAA arranged in the first direction Dx as detection targets.

The signal line selection circuit 16 includes a plurality of selection signal lines Lsel, a plurality of output signal lines Lout, and third switching elements TrS. The third switching elements TrS are provided correspondingly to the signal lines SGL. Six signal lines SGL(1), SGL(2), . . . , SGL(6) are coupled to a common output signal line Lout1. Six signal lines SGL(7), SGL(8), . . . , SGL(12) are coupled to a common output signal line Lout2. The output signal lines Lout1 and Lout2 are each coupled to the AFE circuit 48.

The signal lines SGL(1), SGL(2), . . . , SGL(6) are grouped into a first signal line block, and the signal lines SGL(7), SGL(8), . . . , SGL(12) are grouped into a second signal line block. The selection signal lines Lsel are coupled to the gates of the respective third switching elements TrS included in one of the signal line blocks. One of the selection signal lines Lsel is coupled to the gates of the third switching elements TrS in the signal line blocks.

Specifically, selection signal lines Lsel1, Lsel2, . . . , Lsel6 are coupled to the third switching elements TrS corresponding to the signal lines SGL(1), SGL(2), . . . , SGL(6), respectively. The selection signal line Lsel1 is coupled to one of the third switching elements TrS corresponding to the signal line SGL(1) and one of the third switching elements TrS corresponding to the signal line SGL(7). The selection signal line Lsel2 is coupled to one of the third switching elements TrS corresponding to the signal line SGL(2) and one of the third switching elements TrS corresponding to the signal line SGL(8).

The control circuit 122 (refer to FIG. 1) sequentially supplies the selection signal ASW to the selection signal lines Lsel. This operation causes the signal line selection circuit 16 to operate the third switching elements TrS to sequentially select the signal lines SGL in one of the signal line blocks in a time-division manner. The signal line selection circuit 16 selects one of the signal lines SGL in each of the signal line blocks. Such a configuration can reduce the number of integrated circuits (ICs) including the AFE circuit 48 or the number of terminals of the ICs in the detection device 1.

As illustrated in FIG. 3, the reset circuit 17 includes a reference signal line Lvr, a reset signal line Lrst, and fourth switching elements TrR. The fourth switching elements TrR are provided correspondingly to the signal lines SGL. The reference signal line Lvr is coupled to either the sources or the drains of the fourth switching elements TrR. The reset signal line Lrst is coupled to the gates of the fourth switching elements TrR.

The control circuit 122 supplies a reset signal RST2 to the reset signal line Lrst. This operation turns on the fourth switching elements TrR to electrically couple the signal lines SGL to the reference signal line Lvr. The power supply circuit 123 supplies a reference signal COM to the reference signal line Lvr. This operation supplies the reference signal COM to a capacitive element Ca (refer to FIG. 4) included in each of the pixels PAA.

FIG. 4 is a circuit diagram illustrating the pixels of the detection device according to the embodiment. FIG. 4 also illustrates a circuit configuration of the AFE circuit 48. As illustrated in FIG. 4, the pixel PAA includes the optical sensor PD, the capacitive element Ca, and a corresponding one of the first switching elements Tr. The capacitive element Ca is capacitance (sensor capacitance) generated in the optical sensor PD, and is equivalently coupled in parallel to the optical sensor PD. In addition, signal line capacitance Cc is parasitic capacitance generated on the signal line SGL, and is equivalently provided between the signal line SGL, and the anode of the optical sensor PD and one end side of the capacitive element Ca.

FIG. 4 illustrates two gate lines GCL(m) and GCL(m+1) arranged in the second direction Dy among the gate lines GCL. FIG. 4 also illustrates two signal lines SGL(n) and SGL(n+1) arranged in the first direction Dx among the signal lines SGL. The pixel PAA is an area surrounded by the gate lines GCL and the signal lines SGL.

Each of the first switching elements Tr is provided correspondingly to the optical sensor PD. The first switching element Tr is configured as a thin-film transistor, and in this example, made of an n-channel metal oxide semiconductor (MOS) thin-film transistor (TFT).

The gates of the first switching elements Tr belonging to the pixel PAA arranged in the first direction Dx are coupled to the gate line GCL. The sources of the first switching elements Tr belonging to the pixels PAA arranged in the second direction Dy are coupled to the signal line SGL. The drain of the first switching element Tr is coupled to the cathode of the optical sensor PD and the capacitive element Ca.

The anode of the optical sensor PD is supplied with the sensor power supply signal (potential) VDDSNS from the power supply circuit 123. The cathode of the optical sensor PD is supplied with the reference signal COM that serves as an initial potential of the signal line SGL and the capacitive element Ca from the power supply circuit 123.

When the pixel PAA is irradiated with light, a current corresponding to an amount of light flows through the optical sensor PD. As a result, an electric charge corresponding to the amount of light is stored in the capacitive element Ca. Turning on the first switching element Tr causes a current corresponding to the electric charge stored in the capacitive element Ca to flow through the signal line SGL. The signal line SGL is coupled to the AFE circuit 48 through a corresponding one of the third switching elements TrS of the signal line selection circuit 16. Thus, the detection device 1 can detect a signal corresponding to the amount of light irradiating the optical sensor PD in each of the pixels PAA.

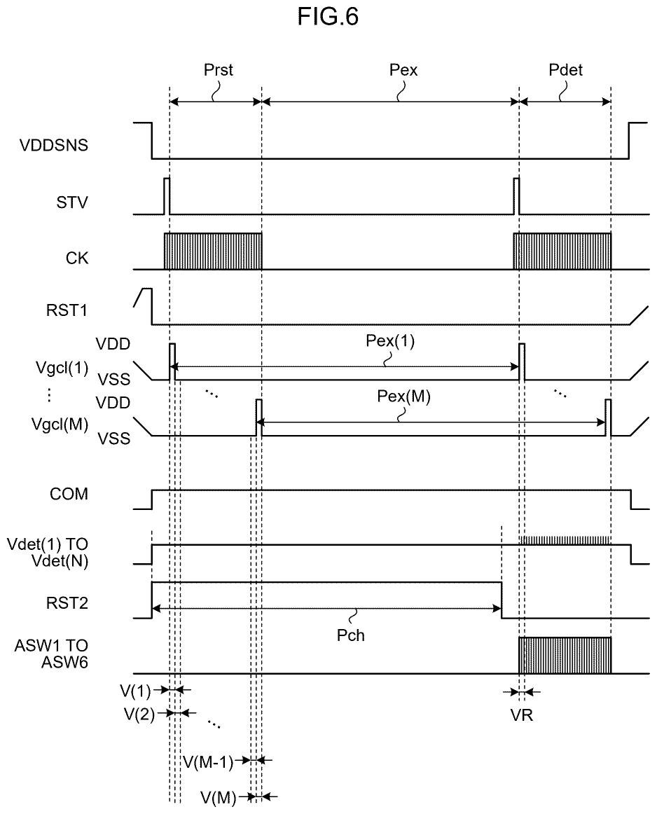

During a readout period Pdet (refer to FIG. 6), a switch SSW of the AFE circuit 48 is turned on to couple the AFE circuit 48 to the signal line SGL. The detection signal amplifying circuit 42 of the AFE circuit 48 converts a current supplied from the signal line SGL into a voltage, and amplifies the result. A reference potential (Vref) having a fixed potential is supplied to a non-inverting input terminal (+) of the detection signal amplifying circuit 42, and the signal lines SGL are coupled to an inverting input terminal (−) of the detection signal amplifying circuit 42. In the embodiment, the same signal as the reference signal COM is supplied as the reference potential (Vref) voltage. The detection signal amplifying circuit 42 includes a capacitive element Cb and a reset switch RSW. During a reset period Prst (refer to FIG. 6), the reset switch RSW is turned on, and the electric charge of the capacitive element Cb is reset.

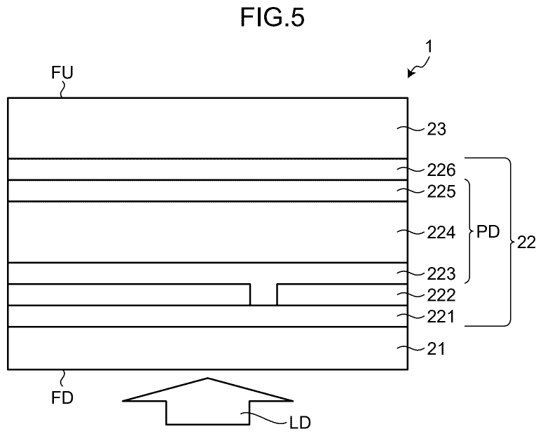

The following describes a configuration of the optical sensor PD. FIG. 5 is a schematic partial sectional view of the optical sensor according to the embodiment. The sensor area 10 of the detection device 1 includes the sensor base member 21, a sensor structure 22, and a protective film 23. The sensor base member 21 is, for example, an insulating base member formed of a film-like resin.

The sensor structure 22 includes a TFT layer 221, an anode electrode (lower electrode) 222, the optical sensor PD, and a cathode electrode (upper electrode) 226.

The TFT layer 221 is provided with various types of wiring such as the gate lines GCL and the signal lines SGL. The sensor base member 21 and the TFT layer 221 are a drive circuit that drives the sensor, and are also called a backplane.

The optical sensor PD includes an active layer 224, an electron transport layer (lower buffer layer) 223 provided between the active layer 224 and the anode electrode (lower electrode) 222, and a hole transport layer (upper buffer layer) 225 provided between the active layer 224 and the cathode electrode (upper electrode) 226. In other words, the electron transport layer (lower buffer layer) 223, the active layer 224, and the hole transport layer (upper buffer layer) 225 of the optical sensor PD are stacked in this order in a direction orthogonal to the sensor base member 21.

The active layer 224 changes in characteristics (for example, voltage-current characteristics and resistance value) depending on light emitted thereto. An organic material is used as a material of the active layer 224. Specifically, the active layer 224 has a bulk heterostructure containing a mixture of a p-type organic semiconductor and an n-type fullerene derivative ((6,6)-phenyl-C₆₁-butyric acid methyl ester (PCBM)) that is an n-type organic semiconductor. As the active layer 224, low-molecular-weight organic materials can be used including, for example, fullerene (C₆₀), phenyl-C₆₁-butyric acid methyl ester (PCBM), copper phthalocyanine (CuPc), fluorinated copper phthalocyanine (Fi₆CuPc), 5,6,11,12-tetraphenyltetracene (rubrene), and perylene diimide (PDI) (derivative of perylene).

The active layer 224 can be formed by a vapor deposition process (dry process) using any of the low-molecular-weight organic materials listed above. In this case, the active layer 224 may be, for example, a multilayered film of CuPc and Fi₆CuPc, or a multilayered film of rubrene and C₆₀. The active layer 224 can also be formed by a coating process (wet process). In this case, the active layer 224 is made using a material obtained by combining any of the above-listed low-molecular-weight organic materials with a high-molecular-weight organic material. As the high-molecular-weight organic material, for example, poly(3-hexylthiophene) (P3HT) and F8-alt-benzothiadiazole (F8BT) can be used. The active layer 224 can be a film made of a mixture of P3HT and PCBM, or a film made of a mixture of F8BT and PDI.

The electron transport layer (lower buffer layer) 223 and the hole transport layer (upper buffer layer) 225 are provided to facilitate the transfer of electrons and holes, which have been generated in the active layer 224, to the anode electrode (lower electrode) 222 or the cathode electrode (upper electrode) 226. The electron transport layer (lower buffer layer) 223 is in direct contact with the top of the anode electrode (lower electrode) 222. The active layer 224 is in direct contact with the top of the electron transport layer (lower buffer layer) 223. Polyethylenimine ethoxylated (PEIE) is used as a material of the electron transport layer (lower buffer layer) 223.

The hole transport layer (upper buffer layer) 225 is in direct contact with the top of the active layer 224, and the cathode electrode (upper electrode) 226 is in direct contact with the top of the hole transport layer (upper buffer layer) 225. The hole transport layer (upper buffer layer) 225 is a metal oxide layer. Tungsten oxide (WO₃), molybdenum oxide, or the like is used as the metal oxide layer.

The materials and the manufacturing methods of the electron transport layer (lower buffer layer) 223, the active layer 224, and the hole transport layer (upper buffer layer) 225 are merely exemplary, and other materials and manufacturing methods may be used.

The anode electrode (lower electrode) 222 faces the cathode electrode (upper electrode) 226 with the optical sensor PD interposed therebetween. A light-transmitting conductive material such as indium tin oxide (ITO) is used as the cathode electrode (upper electrode) 226. A metal material such as silver (Ag) or aluminum (Al) is used as the anode electrode (lower electrode) 222. Alternatively, the anode electrode (lower electrode) 222 may be an alloy material containing at least one or more of these metal materials.

The anode electrode (lower electrode) 222 can be formed as a light-transmitting transflective electrode by controlling the film thickness of the anode electrode (lower electrode) 222. For example, the anode electrode (lower electrode) 222 is formed of an Ag thin film having a thickness of 10 nm so as to have light transmittance of approximately 60%. In this case, the optical sensor PD can detect, for example, first light LD emitted to a first surface FD side.

The protective film 23 is provided on a second surface FU so as to cover the cathode electrode (upper electrode) 226. The protective film 23 is a passivation film and is provided to protect the optical sensor PD.

FIG. 4 illustrates the configuration in which: the sensor power supply signal VDDSNS is supplied from the power supply circuit 123 to the anode of the optical sensor PD; and the reference signal COM serving as the initial potential of the signal line SGL and the capacitive element Ca is supplied from the power supply circuit 123 to the cathode of the optical sensor PD. However, for example, a configuration may be employed in which: the sensor power supply signal VDDSNS is supplied from the power supply circuit 123 to the cathode of the optical sensor PD; and the reference signal COM serving as the initial potential of the signal line SGL and the capacitive element Ca is supplied from the power supply circuit 123 to the anode of the optical sensor PD. In this case, unlike in the configuration described above, the optical sensor PD includes the active layer 224, the hole transport layer (lower buffer layer) 223 provided between the active layer 224 and the cathode electrode (lower electrode) 222, and the electron transport layer (upper buffer layer) 225 provided between the active layer 224 and the anode electrode (upper electrode) 226. In other words, the hole transport layer (lower buffer layer) 223, the active layer 224, and the electron transport layer (upper buffer layer) 225 of the optical sensor PD are stacked in this order in the direction orthogonal to the sensor base member 21.

In the present disclosure, the optical sensor PD is not limited to an organic photodiode (OPD). The optical sensor PD may be a silicon photodiode (SiPD), for example.

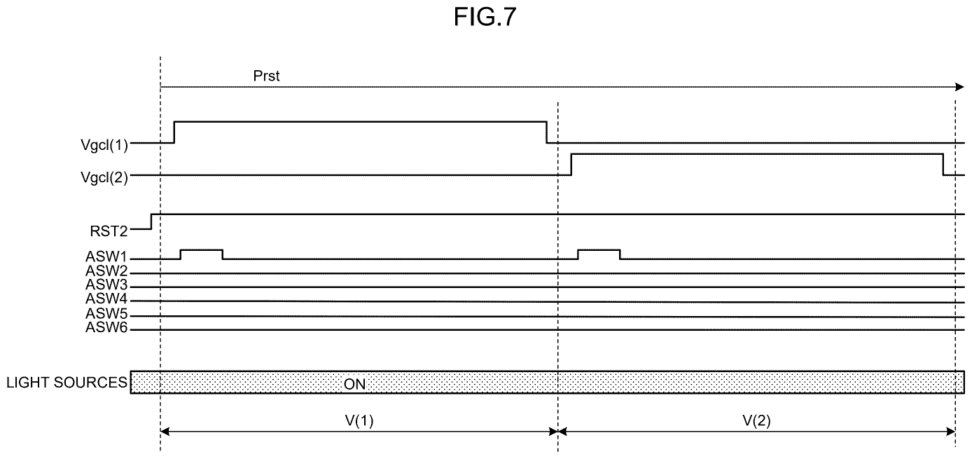

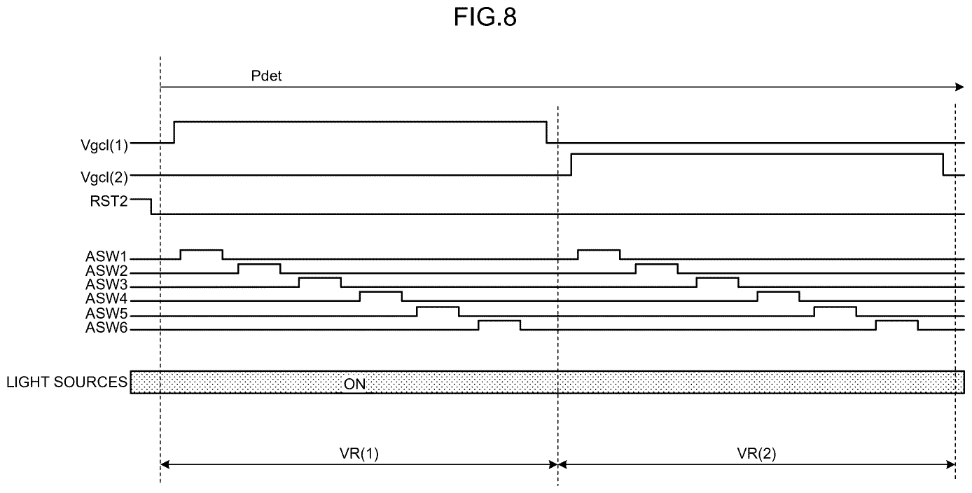

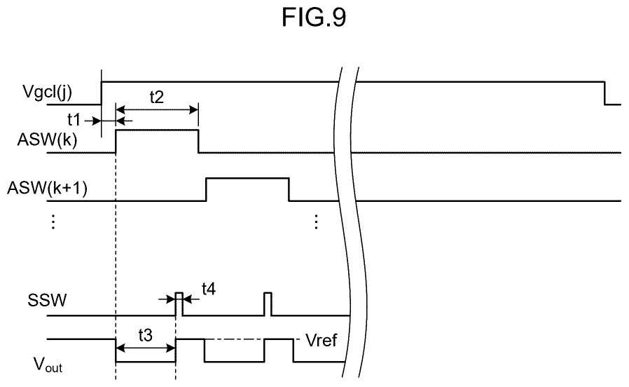

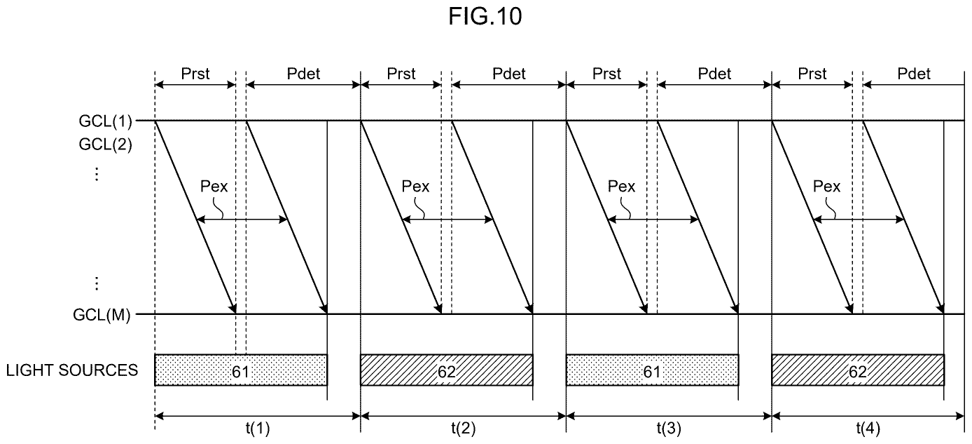

The following describes an operation example of the detection device 1. FIG. 6 is a timing waveform diagram illustrating an operation example in one frame period of the detection device according to the embodiment. FIG. 7 is a timing waveform diagram illustrating an operation example in the reset period in FIG. 6. FIG. 8 is a timing waveform diagram illustrating an operation example in the readout period in FIG. 6. FIG. 9 is a timing waveform diagram illustrating an operation example in a drive period of one gate line included in a row readout period VR in FIG. 6. FIG. 10 is an explanatory diagram for explaining a relation between driving of the sensor area and lighting operations of the light sources in the detection device according to the embodiment.

As illustrated in FIG. 6, the detection device 1 has the reset period Prst, an exposure period Pex, and the readout period Pdet. The power supply circuit 123 supplies the sensor power supply signal VDDSNS to the anode of the optical sensor PD over the reset period Prst, the exposure period Pex, and the readout period Pdet. The sensor power supply signal VDDSNS is a signal that applies a reverse bias between the anode and the cathode of the optical sensor PD. For example, the reference signal COM of substantially 0.75 V is applied to the cathode of the optical sensor PD, and the sensor power supply signal VDDSNS of substantially −1.25 V is applied to the anode thereof. As a result, a reverse bias of substantially 2.0 V is applied between the anode and the cathode. The control circuit 122 sets the reset signal RST2 to “H”, and then, supplies the start signal STV and the clock signal CK to the gate line drive circuit 15 to start the reset period Prst. During the reset period Prst, the control circuit 122 supplies the reference signal COM to the reset circuit 17, and uses the reset signal RST2 to turn on the fourth switching elements TrR for supplying a reset voltage. This operation supplies the reference signal COM as the reset voltage to each of the signal lines SGL. The reference signal COM is set to 0.75 V, for example.

During the reset period Prst, the gate line drive circuit 15 sequentially selects the gate lines GCL based on the start signal STV, the clock signal CK, and the reset signal RST1. The gate line drive circuit 15 sequentially supplies gate drive signals Vgcl{Vgcl(1), . . . , Vgcl(M)} to the gate lines GCL. Each of the gate drive signals Vgcl has a pulsed waveform having a power supply voltage VDD serving as a high-level voltage and a power supply voltage VSS serving as a low-level voltage. In FIG. 6, M gate lines GCL are provided (where M is, for example, 256), and the gate drive signals Vgcl(1), . . . , Vgcl(M) are sequentially supplied to the respective gate lines GCL. Thus, the first switching elements Tr are sequentially brought into a conducting state and supplied with the reset voltage on a row-by-row basis. For example, a voltage of 0.75 V of the reference signal COM is supplied as the reset voltage.

Specifically, as illustrated in FIG. 7, the gate line drive circuit 15 supplies the gate drive signal Vgcl(1) at the high-level voltage (power supply voltage VDD) to the gate line GCL(1) during a period V(1). The control circuit 122 supplies at least one of selection signals ASW1, . . . , ASW6 (selection signal ASW1 in FIG. 7) to the signal line selection circuit 16 during a period in which the gate drive signal Vgcl(1) is at the high-level voltage (power supply voltage VDD). This operation couples, to the AFE circuit 48, the signal line SGL of the pixel PAA selected by the selection signal ASW1. As a result, the reset voltage (reference signal COM) is also supplied to coupling wiring between the third switching element TrS and the AFE circuit 48.

In the same way, the gate line drive circuit 15 supplies the gate drive signals Vgcl(2), . . . , Vgcl(M−1), Vgcl(M) at the high-level voltage to gate lines GCL(2), . . . GCL(M−1), GCL(M) during periods V(2), . . . , V(M−1), V(M), respectively.

Thus, during the reset period Prst, the capacitive elements Ca of all the pixels PAA are sequentially electrically coupled to the signal lines SGL, and are supplied with the reference signal COM. As a result, the capacitance of the capacitive elements Ca is reset. The capacitance of the capacitive elements Ca of some of the pixels PAA can be reset by partially selecting the gate lines and the signal lines SGL.

Examples of the method of controlling the exposure include a method of controlling the exposure during non-selection of the gate lines and a method of always controlling the exposure. In the method of controlling the exposure during non-selection of the gate lines, the gate drive signals {Vgcl(1), . . . , Vgcl(M)} are sequentially supplied to all the gate lines GCL coupled to the optical sensors PD serving as the detection targets, and all the optical sensors PD serving as the detection targets are supplied with the reset voltage. Then, after all the gate lines GCL coupled to the optical sensors PD serving as the detection targets are set to a low voltage (the first switching elements Tr are turned off), the exposure starts and the exposure is performed during the exposure period Pex. After the exposure ends, the gate drive signals {Vgcl(1), . . . , Vgcl(M)} are sequentially supplied to the gate lines GCL coupled to the optical sensors PD serving as the detection targets as described above, and reading is performed during the readout period Pdet. In the method of always controlling the exposure, the control for performing the exposure can also be performed during the reset period Prst and the readout period Pdet (the exposure is always controlled). In this case, the exposure period Pex(1) starts after the gate drive signal Vgcl(1) supplied to the gate line GCL changes from L (VSS) to H (VDD) in the reset period Prst. The exposure periods Pex {(1), . . . , (M)} are substantial exposure periods during which the capacitive elements Ca are charged from the optical sensors PD. No light is emitted except in these periods. The electric charge stored in the capacitive element Ca during the reset period Prst causes a reverse-directional current (from cathode to anode) to flow through the optical sensor PD due to light irradiation, and the potential difference across the capacitive element Ca decreases. The start timing and the end timing of the substantial exposure periods Pex(1), . . . , Pex(M) are different among the pixels PAA corresponding to the gate lines GCL. Each of the exposure periods Pex(1), . . . , Pex(M) starts when the gate drive signal Vgcl changes from the power supply voltage VDD serving as the high-level voltage to the power supply voltage VSS serving as the low-level voltage during the reset period Prst. Each of the exposure periods Pex(1), . . . , Pex(M) ends when the gate drive signal Vgcl changes from the power supply voltage VSS to the power supply voltage VDD during the readout period Pdet. The lengths of exposure time of the exposure periods Pex(1), . . . , Pex(M) are equal.

During the exposure periods Pex {(1) . . . (M)}, a current flows correspondingly to the light irradiating the optical sensor PD in each of the pixels PAA. As a result, an electric charge is stored in each of the capacitive elements Ca.

At a time before the readout period Pdet starts, the control circuit 122 sets the reset signal RST2 to a low-level voltage. This operation stops the operation of the reset circuit 17. The reset signal may be set to a high-level voltage only during the reset period Prst. During the readout period Pdet, the gate line drive circuit 15 sequentially supplies the gate drive signals Vgcl(1), . . . , Vgcl(M) to the gate lines GCL in the same way as that during the reset period Prst.

Specifically, as illustrated in FIG. 8, the gate line drive circuit 15 supplies the gate drive signal Vgcl(1) at the high-level voltage (power supply voltage VDD) to the gate line GCL(1) during a row readout period VR(1). The control circuit 122 sequentially supplies the selection signals ASW1, . . . , ASW6 to the signal line selection circuit 16 while the gate drive signal Vgcl(1) is at the high-level voltage (power supply voltage VDD). This operation sequentially couples the signal lines SGL of the pixels PAA selected by the gate drive signal Vgcl(1) to the AFE circuit 48. As a result, the detection signal Vdet of each of the pixels PAA is supplied to the AFE circuit 48.

In the same way, the gate line drive circuit 15 supplies the gate drive signals Vgcl(2), . . . , Vgcl(M−1), Vgcl(M) at the high-level voltage to the gate lines GCL(2), . . . , GCL(M−1), GCL(M) during row readout periods VR(2), . . . , VR(M−1), VR(M), respectively. That is, the gate line drive circuit 15 supplies the gate drive signal Vgcl to the gate line GCL in each of the row readout periods VR(1), VR(2), . . . , VR(M−1), VR(M). The signal line selection circuit 16 sequentially or simultaneously selects the signal lines SGL based on the selection signal ASW during each period in which the gate drive signal Vgcl is set to the high-level voltage. The signal line selection circuit 16 sequentially or simultaneously couples each of the signal lines SGL to one AFE circuit 48. Thus, the detection device 1 can output the detection signals Vdet of all the pixels PAA to the AFE circuit 48 during the readout period Pdet.

With reference to FIG. 9, the following describes an operation example during the row readout period VR that is a supply period of one gate drive signal Vgcl(j) in FIG. 6. In FIG. 6, the reference numeral of the row readout period VR is assigned to the first gate drive signal Vgcl(1). The same also applies to the other gate drive signals Vgcl(2), . . . , Vgcl(M). j is any one of the natural numbers 1 to M.

As illustrated in FIGS. 9 and 4, an output (Vout) of each of the third switching elements TrS has been reset to the reference potential (Vref) voltage in advance. The reference potential (Vref) voltage serves as the reset voltage, and is set to 0.75 V, for example. Then, the gate drive signal Vgcl(j) is set to a high level, and the first switching elements Tr of a corresponding row are turned on. Thus, each of the signal lines SGL in each row is set to a voltage corresponding to the electric charge stored in the capacitance (capacitive element Ca) of the pixel PAA. After a period t1 elapses from a rising edge of the gate drive signal Vgcl(j), a period t2 starts in which the selection signal ASW(k) is set to a high level. After the selection signal ASW(k) is set to the high level and the third switching element TrS is turned on, the AFE circuit 48 is electrically coupled to the capacitance (capacitive element Ca) of the pixel PAA via the third switching element TrS. This operation changes the output (Vout) of the third switching element TrS (refer to FIG. 4) to a voltage corresponding to the electric charge stored in the capacitance (capacitive element Ca) of the pixel PAA (period t3). In the example of FIG. 9, this voltage is reduced from the reset voltage as illustrated in the period t3. Then, after the switch SSW is turned on (period t4 during which an SSW signal is set to a high level), the electric charge stored in the capacitance (capacitive element Ca) of the pixel PAA is transferred to the capacitance (capacitive element Cb) of the detection signal amplifying circuit 42 of the AFE circuit 48, and the output voltage of the detection signal amplifying circuit 42 is set to a voltage corresponding to the electric charge stored in the capacitive element Cb. At this time, the potential of the inverting input part of the detection signal amplifying circuit 42 is set to a virtual short-circuit potential of an operational amplifier, and therefore, set to the reference potential (Vref). The A/D conversion circuit 43 reads out the output voltage of the detection signal amplifying circuit 42. In the example of FIG. 9, the waveforms of the selection signals ASW(k), ASW(k+1), . . . corresponding to the signal lines SGL of the respective columns are set high to sequentially turn on the third switching elements TrS, and the same operation is sequentially performed to sequentially read out the electric charges stored in the capacitance (capacitive elements Ca) of the pixels PAA coupled to the gate line GCL. ASW(k), ASW(k+1), . . . in FIG. 9 are, for example, any of ASW1 to ASW6 in FIG. 8.

Specifically, after the period t4 starts in which the switch SSW is on, the electric charge is transferred from the capacitance (capacitive element Ca) of the pixel PAA to the capacitance (capacitive element Cb) of the detection signal amplifying circuit 42 of the AFE circuit 48. At this time, the non-inverting input (+) of the detection signal amplifying circuit 42 is set to the reference potential (Vref) voltage (at 0.75 V, for example). Therefore, the output (Vout) of the third switching element TrS is also set to the reference potential (Vref) voltage due to the virtual short-circuit between the inputs of the detection signal amplifying circuit 42. The voltage of the capacitive element Cb is set to a voltage corresponding to the electric charge stored in the capacitance (capacitive element Ca) of the pixel PAA at a location where the third switching element TrS is turned on in response to the selection signal ASW(k). After the output (Vout) of the third switching element TrS is set to the reference potential (Vref) voltage due to the virtual short-circuit, the output of the detection signal amplifying circuit 42 reaches a voltage corresponding to the capacitance of the capacitive element Cb. The A/D conversion circuit 43 reads the output voltage of the detection signal amplifying circuit 42. The voltage of the capacitive element Cb is, for example, a voltage between two electrodes provided on a capacitor constituting the capacitive element Cb.

In the example illustrated in FIG. 10, the detection device 1 executes the reset period Prst, the exposure periods Pex {(1), . . . , (M)}, and the readout period Pdet described above in each of the periods t(1), t(2), t(3), and t(4). In the reset period Prst and the readout period Pdet, the gate line drive circuit 15 sequentially scans the gate lines from GCL(1) to GCL(M). In the following description, the term “one-frame detection” denotes the detection in the periods t(1), t(2), t(3), and t(4), that is, the detection in which the gate lines are scanned from GCL(1) to GCL(M) in the reset period Prst and the readout period Pdet and the detection signals Vdet are acquired from the signal lines SGL in the respective columns.

The control circuit 122 can control the lighting and the non-lighting of the light sources according to the detection target. FIG. 10 illustrates an example in which the first light sources 61 are on during the periods t(1) and t(3), and the second light sources 62 are on during the periods t(2) and t(4). That is, in the first example illustrated in FIG. 10, the control circuit 122 alternately switches on and off the first light sources 61 and the second light sources 62 for each one-frame detection. The present disclosure is not limited to this example. For example, the control circuit 122 may switch between on and off the first light sources 61 and the second light sources 62 at intervals of a predetermined period of time, or may continuously turn on either one of the first and the second light sources 61 and 62.

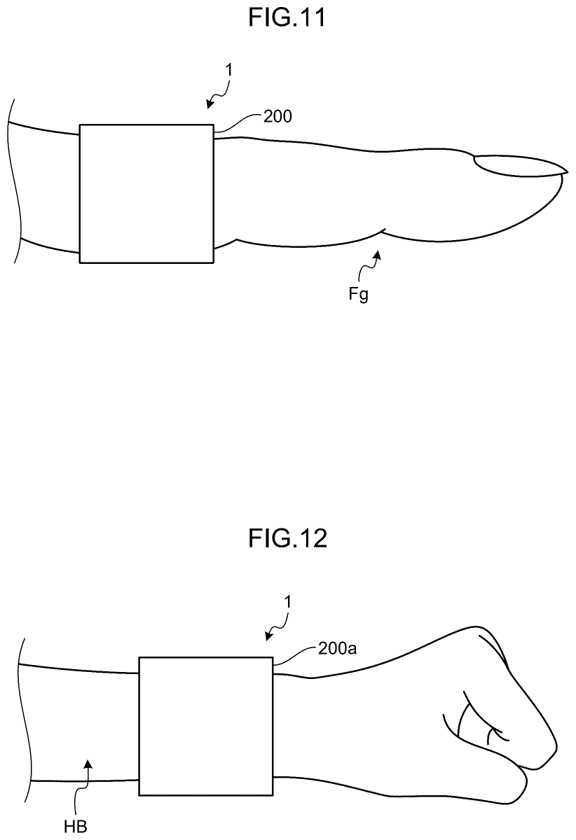

The following describes application examples of the detection device 1 according to the embodiment. FIG. 11 is a schematic view illustrating a first application example of the detection device according to the embodiment. FIG. 12 is a schematic view illustrating a second application example of the detection device according to the embodiment.

In the first application example illustrated in FIG. 11, the detection device 1 a finger ring-shaped wearable device 200 that can be worn on and removed from a human body, and is worn on a finger Fg of the subject person. Examples of the finger Fg include a thumb, an index finger, a middle finger, a ring finger, and a little finger. In the first application example illustrated in FIG. 11, the detection device 1 according to the present disclosure acquires the pulse waves from the finger Fg wearing the wearable device 200.

In the second application example illustrated in FIG. 12, the detection device 1 is a ring-shaped wearable device 200a, such as a smartwatch, a wristwatch, or a wristband, and is worn on a human body HB of the subject person. Examples of the human body HB include, but are not limited to, a wrist, an arm, and a leg of the subject person. In the second application example illustrated in FIG. 12, the detection device 1 acquires the pulse waves from the human body HB (such as the arm of the subject person) wearing the wearable device 200a.

When the wearable device 200 or 200a (refer to FIG. 11 or 12) to which the detection device 1 having the configuration described above is applied is worn on the human body to acquire the pulse waves, periodic body motion noise generated by walking or the like may be erroneously determined as the pulse waves.

The following describes a specific example of a process capable of reducing the periodic body motion noise when acquiring the biometric information.

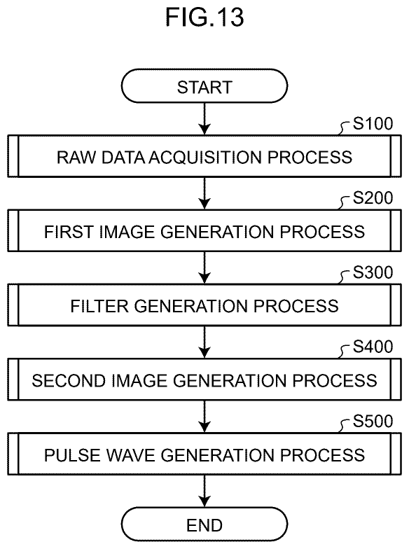

FIG. 13 is a flowchart illustrating an example of a detection process in the detection device according to the embodiment. Each process illustrated in FIG. 13 is performed mainly by the signal processing circuit 44 of the detection circuit 40.

In the following description, X<n,m> denotes a variable of the pixel PAA in the nth column and the mth row. The variable X<n,m> contains coordinate information on the pixel PAA from which the variable X<n,m> has been obtained. X(f)<n,m> denotes the variable X<n,m> in the fth frame.

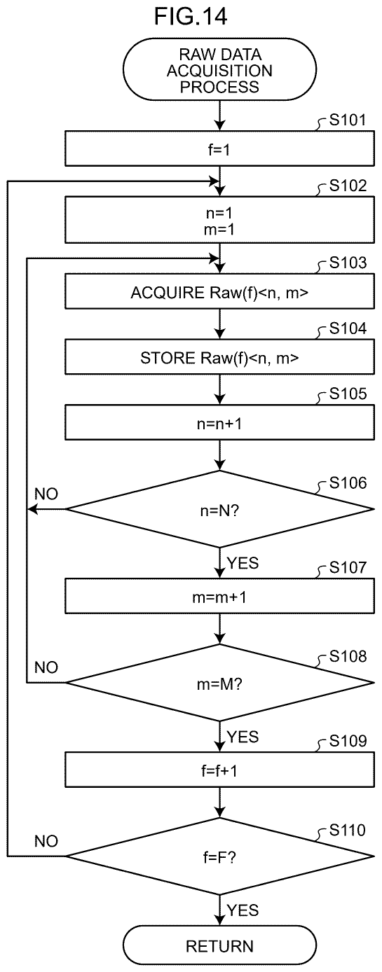

In the detection process illustrated in FIG. 13, the signal processing circuit 44 first performs a Raw data acquisition process illustrated in FIG. 14 to acquire detection values Raw(f)<n,m> of the respective pixels PAA in the sensor area 10 for a plurality of frames (Step S100 in FIG. 13). FIG. 14 is a sub-flowchart illustrating an example of the Raw data acquisition process.

The number of the frames F in acquiring the detection values Raw(f)<n,m> for the multiple frames is set to the number of times (such as approximately 10 times) the peaks of the pulse waves can be acquired. The number of the frames F is defined by Expression (1) given below, where P denotes the acquisition period of the detection value Raw(f)<n,m> and t denotes the sampling cycle. The acquisition period P of the detection value Raw(f)<n,m> is set to, for example, 10 seconds to 20 seconds. The number of the frames F is stored in the storage circuit 46, for example.

F=P/t (1)

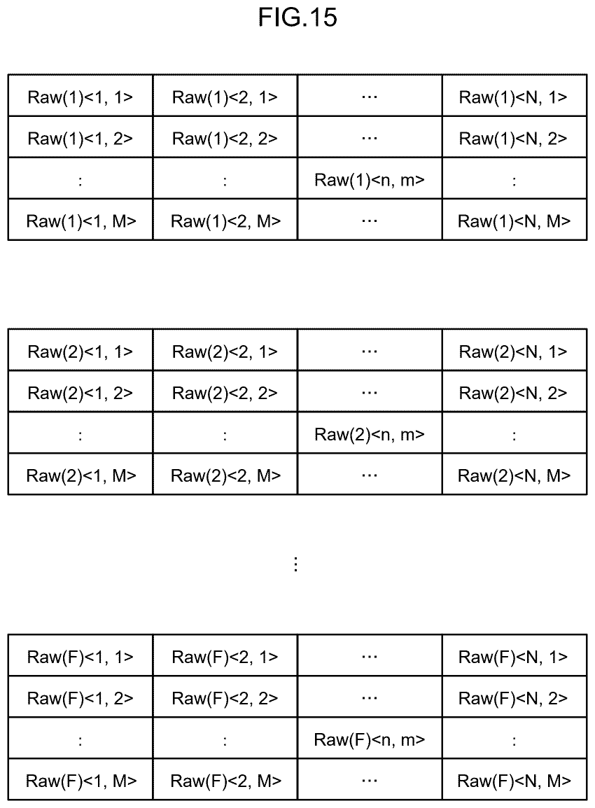

In the Raw data acquisition process illustrated in FIG. 14, the signal processing circuit 44 sets an initial frame f to 1 (f=1) (Step S101), n to 1 and m to 1 (Step S102), acquires the detection value Raw(f)<n,m> (Step S103), and stores the acquired detection value Raw(f)<n,m> in the storage circuit 46 (Step S104). FIG. 15 is a table illustrating the detection values of each of the pixels in the detection area for F frames.

The signal processing circuit 44 then sets n=n+1 (Step S105) and determines whether n is N (n=N) (Step S106). If n is less than N (n<N) (No at Step S106), the process returns to Step S103.

When n reaches N (n=N) (Yes at Step S106), the signal processing circuit 44 then sets m=m+1 (Step S107) and determines whether m is M (m=M) (Step S108). If m is less than M (m<M) (No at Step S108), the process returns to Step S103.

If m reaches M (m=M) (Yes at Step S108), the signal processing circuit 44 then sets f=f+1 (Step S109) and determines whether f is F (f=F) (Step S110). If f is less than F (f<F) (No at Step S110), the process returns to Step S102.

By repeating the processes described above from Step S102 to Step S110 F times, the detection values Raw(f)<n,m> of each of the pixels PAA for F frames are stored in the storage circuit 46.

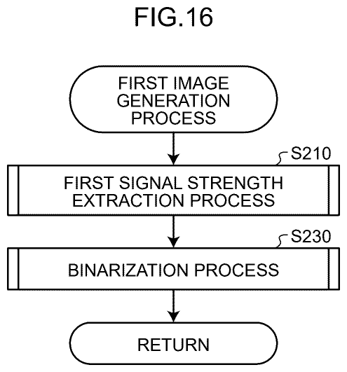

If f reaches F (f=F) (Yes at Step S110), the process returns to the detection process illustrated in FIG. 13, and the signal processing circuit 44 then performs a first image generation process illustrated in FIG. 16 (Step S200 in FIG. 13). FIG. 16 is a sub-flowchart illustrating an example of the first image generation process.

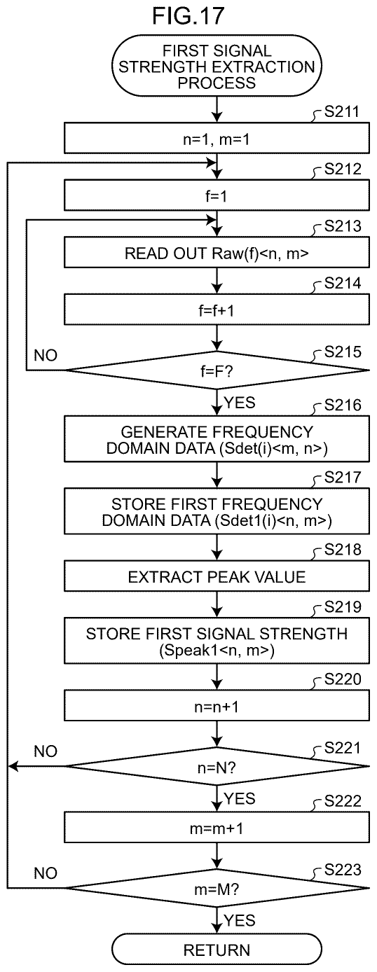

In the first image generation process illustrated in FIG. 16, the signal processing circuit 44 first performs a first signal strength extraction process (Step S210 in FIG. 16). FIG. 17 is a sub-flowchart illustrating an example of the first signal strength extraction process.

In the first signal strength extraction process illustrated in FIG. 17, the signal processing circuit 44 sets n=1 and m=1 (Step S211), sets the initial frame f to 1 (f=1) (Step S212), and reads out the detection value Raw(f)<n,m> from the storage circuit 46 (Step S213). In addition, the signal processing circuit 44 sets f=f+1 (Step S214) and determines whether f is F (f=F) (Step S215). If f is less than F (f<F) (No at Step S215), the process returns to Step S213.

By performing the processes described above from Step S213 to Step S215, the detection values Raw(f)<n,m> of the pixel PAA in the nth column and the mth row for F frames are read out.

When f reaches F (f=F) (Yes at Step S215), the signal processing circuit 44 generates frequency domain data Sdet(i)<m,n> by performing a Fourier transform process (herein, a fast Fourier transform (FFT) process) on the detection values Raw(f)<n,m> for F frames serving as the time domain data read from the storage circuit 46 (Step S216).

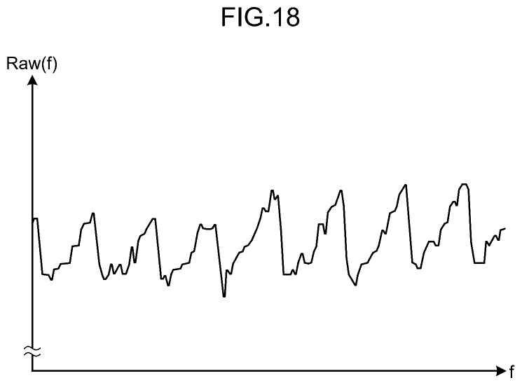

FIG. 18 is a diagram illustrating an example of the time domain data. In FIG. 18, the horizontal axis indicates the frame f (time), and the vertical axis indicates the detection value Raw(f)<n,m> corresponding to each frame f.

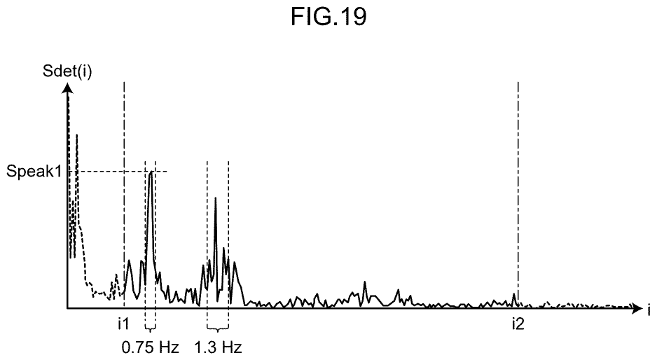

FIG. 19 is a diagram illustrating an example of the frequency domain data. In FIG. 19, the horizontal axis indicates a frequency line i, and the vertical axis indicates a signal strength Sdet(i)<n,m> corresponding to each frequency line i. The number of the frequency lines I in the frequency domain data is defined by Expression (2) given below.

I=1/(F×t) (2)

The signal processing circuit 44 then limits the frequency domain data illustrated in FIG. 19 within a frequency range equal to or higher than a first frequency line i1 and lower than a second frequency line i2, stores the result in the storage circuit 46 as first frequency domain data (signal strength Sdet1(i)<n,m>) (Step S217). The signal processing circuit 44 extracts a peak value in the first frequency domain data (signal strength Sdet1(i)<n,m>) (Step S218). The frequency corresponding to the first frequency line i1 is set to 0.5 Hz, for example, and the frequency corresponding to the second frequency line i2 is set to 4 Hz, for example. The first frequency domain data (signal strength Sdet1(i)<n,m>) is stored in the storage circuit 46.

The signal processing circuit 44 stores the peak value extracted at Step S218 in the storage circuit 46 as a first signal strength Speak1<n,m> of the pixel PAA in the nth column and the mth row (Step S219).

In the example illustrated in FIG. 19, signal components around 0.75 Hz are body motion components, and signal components around 1.3 Hz are pulse wave components. This example illustrates an example in which the signal strength of the frequency line corresponding to the body motion components is extracted as the first signal strength Speak1<n,m>.

The signal processing circuit 44 then sets n=n+1 (Step S220) and determines whether n is N (n=N) (Step S221). If n is less than N (n<N) (No at Step S221), the process returns to Step S212.

If n reaches N (n=N) (Yes at Step S221), the signal processing circuit 44 then sets m=m+1 (Step S222) and determines whether m is M (m=M) (Step S223). If m is less than M (m<M) (No at Step S223), the process returns to Step S212.

By repeating the above-described processes from Step S212 to Step S223 N×M times, the first frequency domain data (signal strength Sdet1(i)<n,m>) and the first signal strength Speak1<n,m> of each of the pixels PAA are stored in the storage circuit 46.

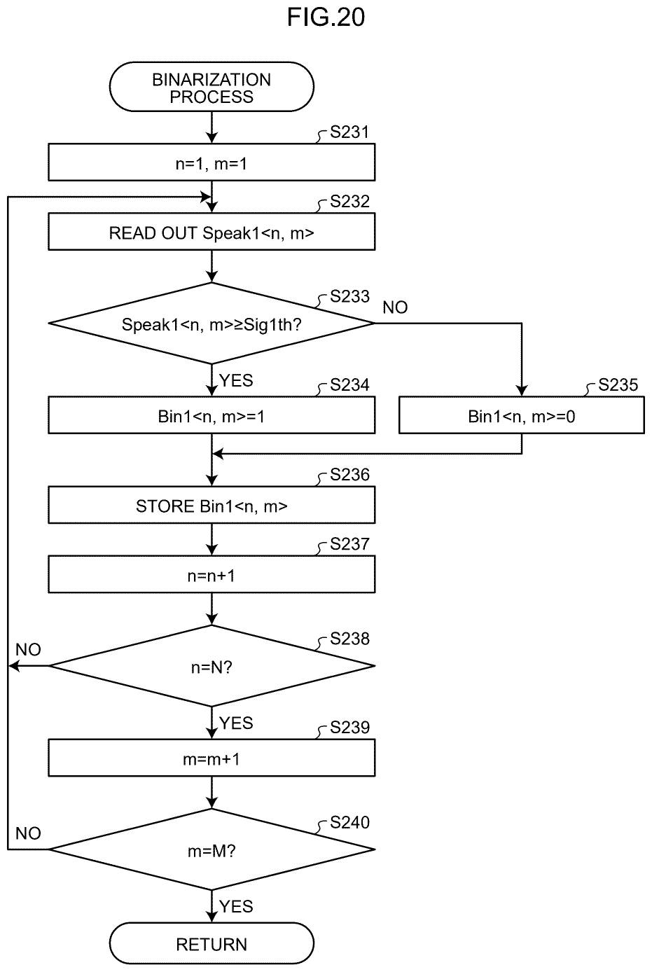

If m reaches M (m=M) (Yes at Step S223), the process returns to the first image generation process illustrated in FIG. 16, and then, the signal processing circuit 44 performs a binarization process illustrated in FIG. 20 (Step S230 in FIG. 16). FIG. 20 is a sub-flowchart illustrating an example of the binarization process in the first image generation process.

In the binarization process illustrated in FIG. 20, the signal processing circuit 44 sets n=1 and m=1 (Step S231), reads out the first signal strength Speak1<n,m> from the storage circuit 46 (Step S232), and determines whether the read out first signal strength Speak1<n,m> is equal to or higher than a predetermined threshold Sig1th (Speak1<n,m>>Sig1th) (Step S233).

If the first signal strength Speak1<n,m> is equal to or higher than the threshold Sig1th (Yes at Step S233), a first binary value Bin1<n,m> of the pixel PAA in the nth column and the mth row is set to “1” (Bin1<n,m>=1 at Step S234) and stored in the storage circuit 46 (Step S236).

If the first signal strength Speak1<n,m> is lower than the threshold Sig1th (No at Step S233), the first binary value Bin1<n,m> of the pixel PAA in the nth column and the mth row is set to “0” (Bin1<n,m>=0, at Step S235) and stored in the storage circuit 46 (Step S236).

The signal processing circuit 44 then sets n=n+1 (Step S237) and determines whether n is N (n=N) (Step S238). If n is less than N (n<N) (No at Step S238), the process returns to Step S232.

If n reaches N (n=N) (Yes at Step S238), the signal processing circuit 44 then sets m=m+1 (Step S239) and determines whether m is M (m=M) (Step S240). If m is less than M (m<M) (No at Step S240), the process returns to Step S232.

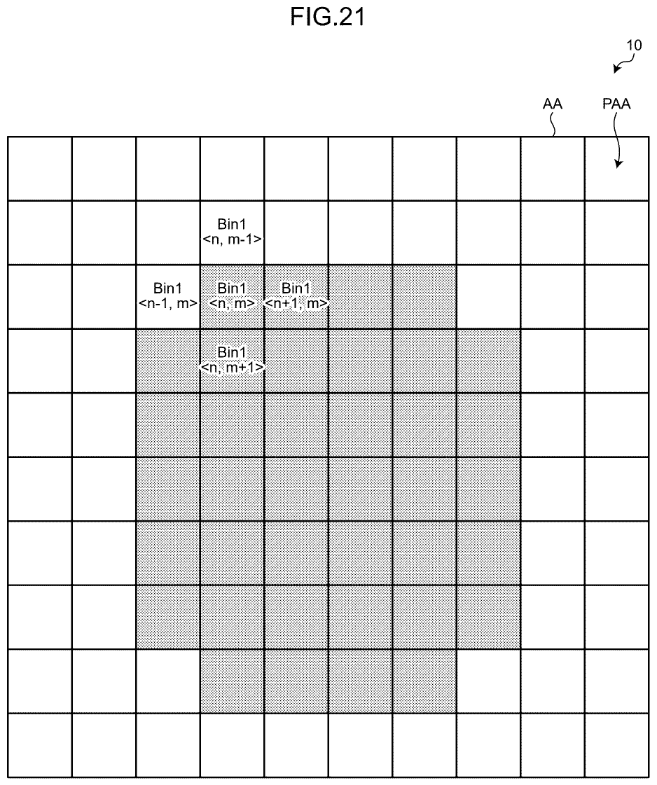

By repeating the above-described processes from Step S232 to Step S240 N×M times, the first binary value Bin1<n,m> of each of the pixels PAA is stored in the storage circuit 46. By applying the first binary value Bin1<n,m> of each of the pixels PAA to the sensor area 10, an illustrative image illustrated in FIG. 21 is generated.

FIG. 21 is a diagram illustrating a specific example of the illustrative image obtained by converting the first binary values of the respective pixels into an image. FIG. 21 illustrates the example in which first binary values Bin1<n,m>, Bin1<n+1,m>, and Bin1<n,m+1> are “1” and first binary values Bin1<n,m−1> and Bin1<n−1,m> are “0”.

In the present disclosure, a “first area” is defined as an area where the first binary value Bin1 is “1” in the illustrative image illustrated in FIG. 21. In other words, the first area represents an area where the first signal strength Speak1<n,m> is equal to or higher than the threshold Sig1th in the illustrative image illustrated in FIG. 21.

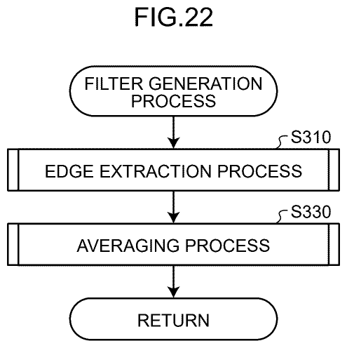

If m reaches M (m=M) (Yes at Step S240), the process returns from the first image generation process illustrated in FIG. 16 to the detection process illustrated in FIG. 13, and then, the signal processing circuit 44 performs a filter generation process illustrated in FIG. 22 (Step S300 in FIG. 13). FIG. 22 is a sub-flowchart illustrating an example of the filter generation process.

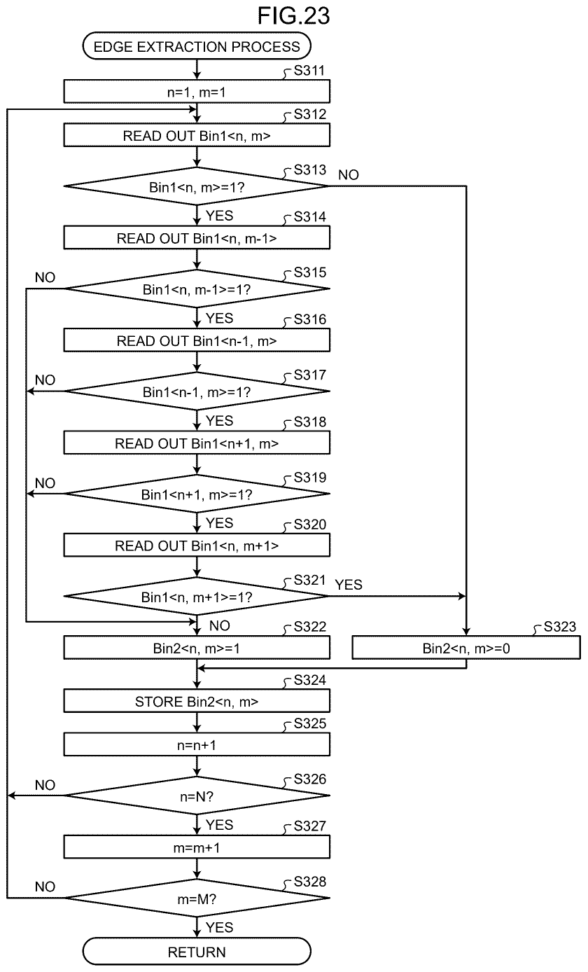

In the filter generation process illustrated in FIG. 22, the signal processing circuit 44 first performs an edge extraction process (Step S310 in FIG. 22). FIG. 23 is a sub-flowchart illustrating an example of the edge extraction process.

In the edge extraction process illustrated in FIG. 23, the signal processing circuit 44 sets n=1 and m=1 (Step S311), reads out the first binary value Bin1<n,m> from the storage circuit 46 (Step S312), and determines whether the first binary value Bin1<n,m> is “1” (Bin1<n,m>=1) (Step S313).

If the first binary value Bin1<n,m> is “1” (Yes at Step S313), the signal processing circuit 44 then reads out the first binary value Bin1<n,m−1> from the storage circuit 46 (Step S314) and determines whether the first binary value Bin1<n,m−1> is “1” (Bin1<n,m−1>=1) (Step S315).

If the first binary value Bin1<n,m−1> is “1” (Yes at Step S315), the signal processing circuit 44 then reads out the first binary value Bin1<n−1,m> from the storage circuit 46 (Step S316) and determines whether the first binary value Bin1<n−1,m> is “1” (Bin1<n−1,m>=1) (Step S317).

If the first binary value Bin1<n−1,m> is “1” (Yes at Step S317), the signal processing circuit 44 then reads out the first binary value Bin1<n+1,m> from the storage circuit 46 (Step S318) and determines whether the first binary value Bin1<n+1,m> is “1” (Bin1<n+1,m>=1) (Step S319).

If the first binary value Bin1<n+1,m> is “1” (Yes at Step S319), the signal processing circuit 44 then reads the first binary value Bin1<n,m+1> from the storage circuit 46 (Step S320) and determines whether the first binary value Bin1<n,m+1> is “1” (Bin1<n,m+1>=1) (Step S321).

If the first binary value Bin1<n,m> is “1” (Yes at Step S313), and if the first binary value Bin1<n,m−1> is “0” (No at Step S315), or the first binary value Bin1<n−1,m> is “0” (No at Step S317), or the first binary value Bin1<n+1,m> is “0” (No at Step S319), or the first binary value Bin1<n,m+1> is “0” (No at Step S321), the signal processing circuit 44 sets a second binary value Bin2<n,m> of the pixel PAA in the nth column and the mth row to “1” (Bin2<n,m>=1 at Step S322), and stores the second binary value Bin2<n,m> in the storage circuit 46 (Step S324).

If the first binary value Bin1<n,m> is “0” (No at Step S313) or the first binary value Bin1<n,m> is “1” (Yes at Step S313), and if the first binary value Bin1<n,m−1> is “1” (Yes at Step S315), and the first binary value Bin1<n−1,m> is “1” (Yes at Step S317), and the first binary value Bin1<n+1,m> is “1” (Yes at Step S319), and the first binary value Bin1<n,m+1> is “1” (Yes at Step S321). the signal processing circuit 44 sets the second binary value Bin2<n,m> of the pixel PAA in the nth column and the mth row to “0” (Bin2<n,m>=0 at Step S323), and stores the second binary value Bin2<n,m> in the storage circuit 46 (Step S324).

The signal processing circuit 44 then sets n=n+1 (Step S325) and determines whether n is N (n=N) (Step S326). If n is less than N (n<N) (No at Step S326), the process returns to Step S312.

If n reaches N (n=N) (Yes at Step S326), the signal processing circuit 44 then sets m=m+1 (Step S327) and determines whether m is M (m=M) (Step S328). If m is less than M (m<M) (No at Step S328), the process returns to Step S312.

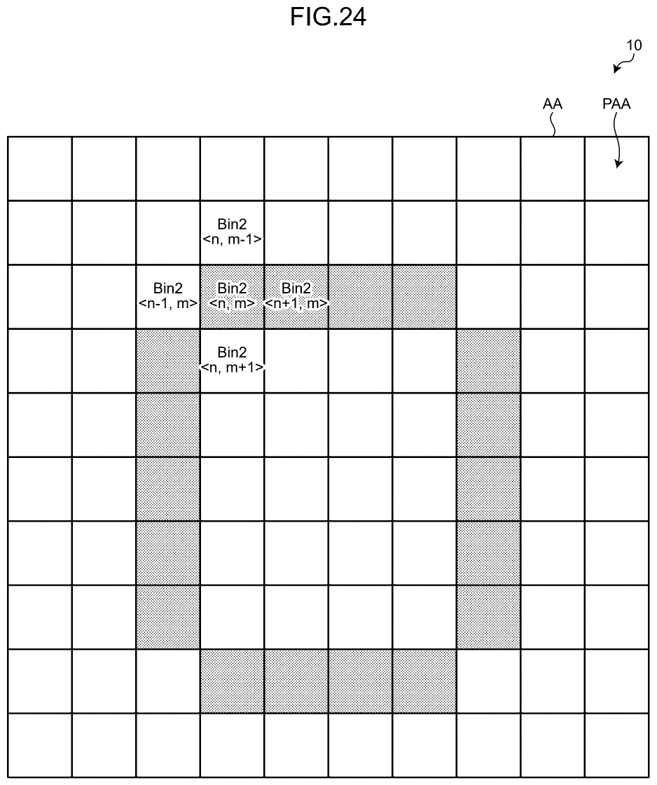

By repeating the above-described processes from Step S312 to Step S328 N×M times, the second binary value Bin2<n,m> of each of the pixels PAA is stored in the storage circuit 46. By applying the second binary value Bin2<n,m> of each of the pixels PAA to the sensor area 10, an illustrative image illustrated in FIG. 24 is generated.

FIG. 24 is a diagram illustrating a specific example of the illustrative image obtained by converting the second binary values of the respective pixels into an image. FIG. 24 illustrates the example in which second binary values Bin2<n,m> and Bin2<n+1,m> are “1” and second binary values Bin2<n,m−1>, Bin2<n−1,m>, and Bin2<n,m+1> are “0”.

The edge extraction process described above is an example. For example, in an aspect, a known contour tracking process algorithm may be used to extract the pixels PAA located at the outer periphery of the first area (refer to FIG. 21).

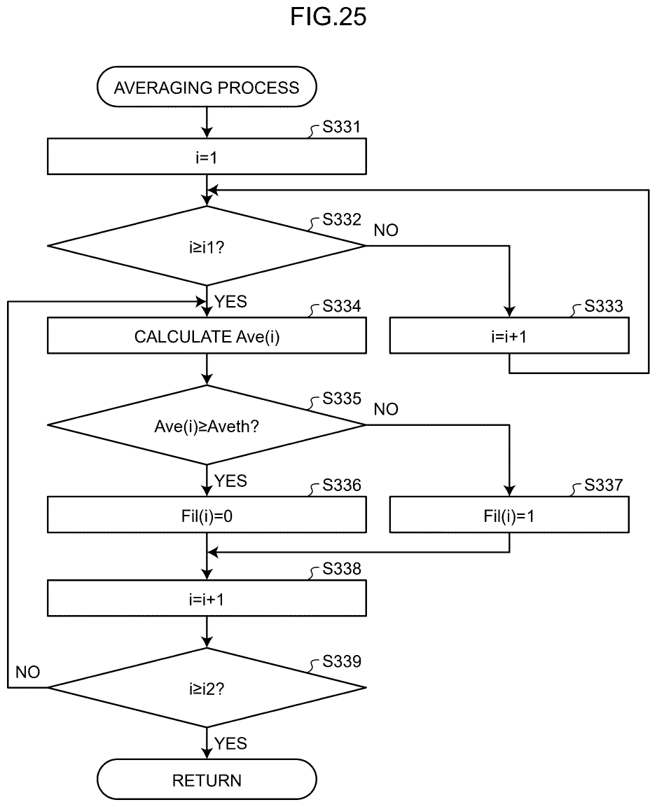

If m reaches M (m=M) (Yes at Step S328), the process returns to the filter generation process illustrated in FIG. 22, and the signal processing circuit 44 then performs an averaging process illustrated in FIG. 25 (Step S330 in FIG. 22). FIG. 25 is a sub-flowchart illustrating an example of the averaging process.

In the averaging process illustrated in FIG. 25, the signal processing circuit 44 sets i=1 (Step S331), and determines whether the frequency line i is equal to or higher than the first frequency line i1 (step S332). If the frequency line i is lower than the first frequency line i1 (No at Step S332), the signal processing circuit 44 increments the frequency line i by 1 (i=i+1 at Step S333) and repeats the processes at Step S332 and Step S333 until the frequency line i becomes equal to or higher than the first frequency line i1 (Yes at Step S332).

If the frequency line i is equal to or higher than the first frequency line i1 (Yes at Step S332), the signal processing circuit 44 calculates an average Ave(i) of the values of the first frequency domain data (signal strength Sdet1(i)<n,m>) of all the pixels PAA included in an area where the second binary value Bin2 is “1”, for each of the frequency lines i in the illustrative image illustrated in FIG. 24 (Step S334). The average Ave(i) for each of the frequency lines i can be expressed by Expression (3) given below.

Ave(i)=ΣSdet1(i)<n,m>/ΣBin2<n,m> (3)

The signal processing circuit 44 then generates a filter value Fi1(i) corresponding to the frequency line i by performing a threshold-based determination process for the average Ave(i) calculated at Step S334. Specifically, the signal processing circuit 44 determines whether the average Ave(i) calculated at Step S334 is equal to or higher than a predetermined threshold Aveth (Step S335).

If the average Ave(i) is higher than the threshold Aveth (Yes at Step S335), the signal processing circuit 44 sets the filter value Fi1(i) to “0” and stores it in the storage circuit 46 (Step S336). If the average Ave(i) is lower than the threshold Aveth (No at Step S335), the signal processing circuit 44 sets the filter value Fi1(i) to “1” and stores it in the storage circuit 46 (Step S337).

The signal processing circuit 44 then increments the frequency line i by 1 (i=i+1 at Step S338) and determines whether the frequency line i is equal to or higher than the second frequency line i2 (i≥i2) (Step S339). If the frequency line i is lower than the second frequency line i2 (i<i2) (No at Step S339), the process returns to Step S334.

By repeating the above-described processes from Step S334 to Step S339, the filter value Fi1(i) corresponding to the frequency line i representing the signal strength Ave(i) after the averaging process of equal to or higher than the threshold Aveth is stored as “0” in the storage circuit 46, and the filter value Fi1(i) corresponding to the frequency line i representing the signal strength Ave(i) after the averaging process of lower than the threshold Aveth is stored as “1” in the storage circuit 46.

If the frequency line i becomes equal to or higher than the second frequency line i2 (i≥i2) (Yes at Step S339), the process returns from the filter generation process illustrated in FIG. 22 to the detection process illustrated in FIG. 13.

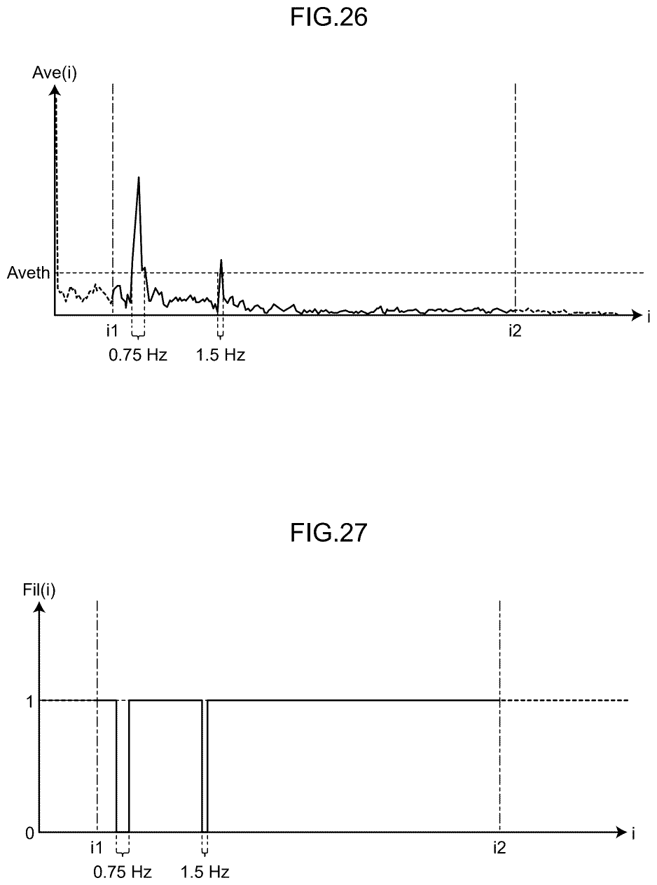

FIG. 26 is a diagram illustrating an example of the average of the signal strengths of the multiple pixels in the illustrative image illustrated in FIG. 24. FIG. 27 is a diagram illustrating an example of the filter value. In FIGS. 26 and 27, the horizontal axis indicates the frequency line i. The vertical axis in FIG. 26 indicates the average Ave(i) corresponding to each frequency line i. The vertical axis in FIG. 27 indicates the filter value Fi1(i) corresponding to each frequency line i.

As illustrated in FIGS. 26 and 27, as a result of the processes described above, the filter value Fi1 is “0” for the frequency lines representing the average Ave of equal to or higher than the threshold Aveth. In the examples illustrated in FIGS. 26 and 27, the filter value Fi1 around 0.75 Hz and the filter value Fi1 around 1.5 Hz are “0”.

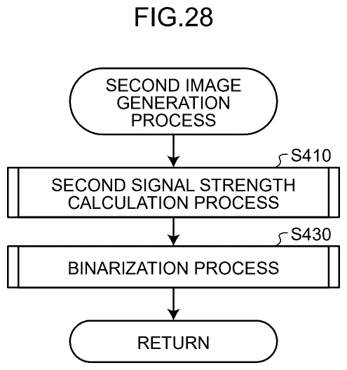

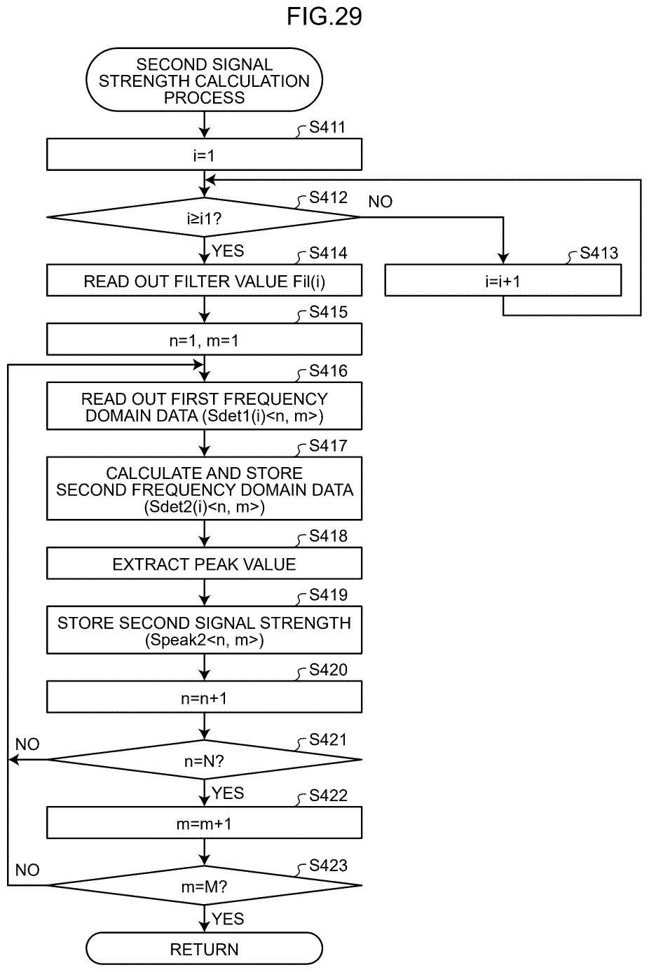

In the present disclosure, the process returns from the filter generation process illustrated in FIG. 22 to the detection process illustrated in FIG. 13, a second image generation process illustrated in FIG. 28 is performed (Step S400 in FIG. 13), and the filter value Fi1(i) is applied to the first frequency domain data (signal strength Sdet1(i)<n,m>) in a second signal strength calculation process illustrated in FIG. 29 (Step S410 in FIG. 28). This operation reduces the signal strength corresponding to the frequency line representing the filter value Fi1(i) of “0”.

FIG. 28 is a sub-flowchart illustrating an example of the second image generation process. FIG. 29 is a sub-flowchart illustrating an example of the second signal strength calculation process.

In the second signal strength calculation process illustrated in FIG. 29, the signal processing circuit 44 sets i=1 (Step S411), and determines whether the frequency line i is equal to or higher than the first frequency line i1 (Step S412). If the frequency line i is lower than the first frequency line i1 (No at Step S412), the signal processing circuit 44 increments the frequency line i by 1 (i=i+1 at Step S413) and repeats the processes at Step S412 and Step S413 until the frequency line i becomes equal to or higher than the first frequency line i1 (Yes at Step S412).

If the frequency line i becomes equal to or higher than the first frequency line i1 (Yes at Step S412), the signal processing circuit 44 reads out the filter value Fi1(i) corresponding to frequency line i from the storage circuit 46 (Step S414).

The signal processing circuit 44 then sets n=1 and m=1 (Step S415), reads out the first frequency domain data (signal strength Sdet1(i)<n,m>) from the storage circuit 46 (Step S416), calculates second frequency domain data (signal strength Sdet2(i)<n,m>) by multiplying the signal strength Sdet1(i)<n,m> corresponding to the frequency line i of the read out first frequency domain data by the filter value Fi1(i) corresponding to the frequency line i, and stores the result in the storage circuit 46 (Step S417). The second frequency domain data (signal strength Sdet2(i)<n,m>) can be expressed by Expression (4) given below.

Sdet2(i)<n,m>=Sdet1(i)<n,m>×Fi1(i) (4)

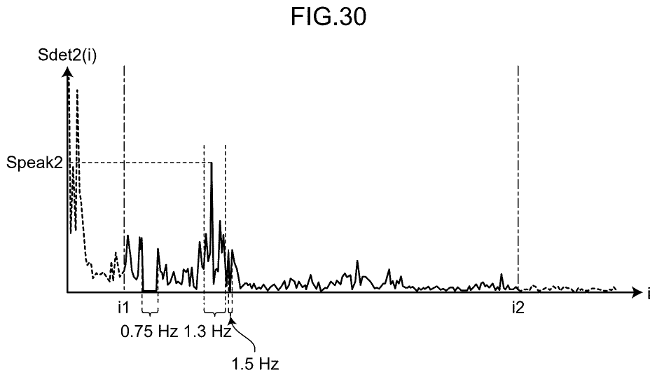

FIG. 30 is a diagram illustrating an example of the second frequency domain data. In FIG. 30, the horizontal axis indicates the frequency line i, and the vertical axis indicates the signal strength Sdet2(i)<n,m> corresponding to each frequency line i. As illustrated in FIG. 30, the second frequency domain data (signal strength Sdet2(i)<n,m>) in which the signal strength corresponding to the frequency line representing the filter value Fi1(i) of “0” is reduced is obtained by applying the filter value Fi1(i) corresponding to frequency line i to the first frequency domain data (signal strength Sdet1(i)<n,m>) of each of the pixels PAA. If the frequency corresponding to the frequency line representing the filter value Fi1(i) of “0” overlaps the frequency of the body motion components, the second frequency domain data (signal strength Sdet2(i)<n,m>) in which the body motion components are reduced is obtained.

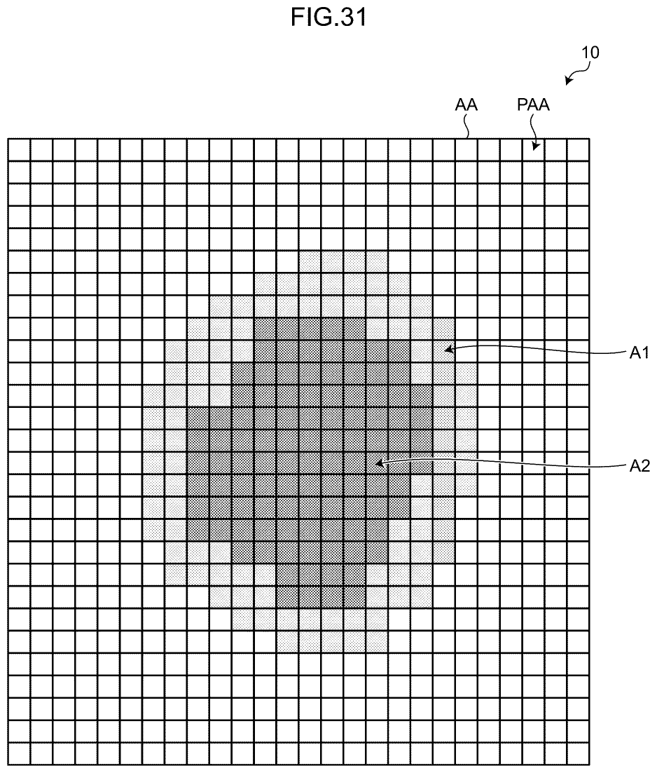

FIG. 31 is a schematic diagram illustrating a positional relation between a pulse wave component detection area and a body motion noise component detection area in the sensor area. In FIG. 31, an area A1+A2 including areas A1 and A2 represents an area where the binarized value of the signal strengths of the frequency components corresponding to the body motion noise is “1”. In contrast, the area A2 excluding the area A1 represents an area where the binarized value of the signal strengths of the frequency components corresponding to the pulse wave components is “1”. In other words, the area A1 in the area A1+A2 represents an area where the binarized value of the signal strengths of the frequency components corresponding to the pulse wave components is “0”.

As illustrated in FIG. 31, the area A1+A2 is larger than the area A2, and the area A2 is included inside the area A1+A2. In the present disclosure, the second frequency domain data (signal strength Sdet2(i)<n,m>) is calculated by setting, to “0”, the filter value Fi1(i) corresponding to the frequency line representing the average Ave(i) of the first frequency domain data (signal strength Sdet1(i)<n,m>) at an edge corresponding to the area A1 of equal to or higher than the predetermined threshold Aveth, and applying the filter value Fi1(i) to the first frequency domain data (signal strength Sdet1(i)<n,m>) of each of the pixels PAA in the entire sensor area 10 (detection area AA). Thus, the second frequency domain data (signal strength Sdet2(i)<n,m>) in which the body motion components are reduced is obtained. Specifically, the example illustrated in FIG. 30 illustrates that the signal components around 0.75 Hz and 1.5 Hz are reduced as the body motion components.

The signal processing circuit 44 then extracts the peak value in the second frequency domain data (signal strength Sdet2(i)<n,m>) (Step S418) and stores the peak value as a second signal strength Speak2<n,m> in the storage circuit 46 (Step S419).

In the example illustrated in FIG. 30, the signal components around 1.3 Hz are the pulse wave components. This example illustrates an example in which the signal strength of the frequency line corresponding to the pulse wave components is extracted as the second signal strength Speak2<n,m>.

The signal processing circuit 44 then sets n=n+1 (Step S420) and determines whether n is N (n=N) (Step S421). If n is less than N (n<N) (No at Step S421), the process returns to Step S416.

If n reaches N (n=N) (Yes at Step S421), the signal processing circuit 44 then sets m=m+1 (Step S422) and determines whether m is M (m=M) (Step S423). If m is less than M (m<M) (No at Step S423), the process returns to Step S416.

By repeating the above-described processes from Step S416 to Step S423 N×M times, the second frequency domain data (signal strength Sdet2(i)<n,m>) and the second signal strength Speak2<n,m> of each of the pixels PAA are stored in the storage circuit 46.

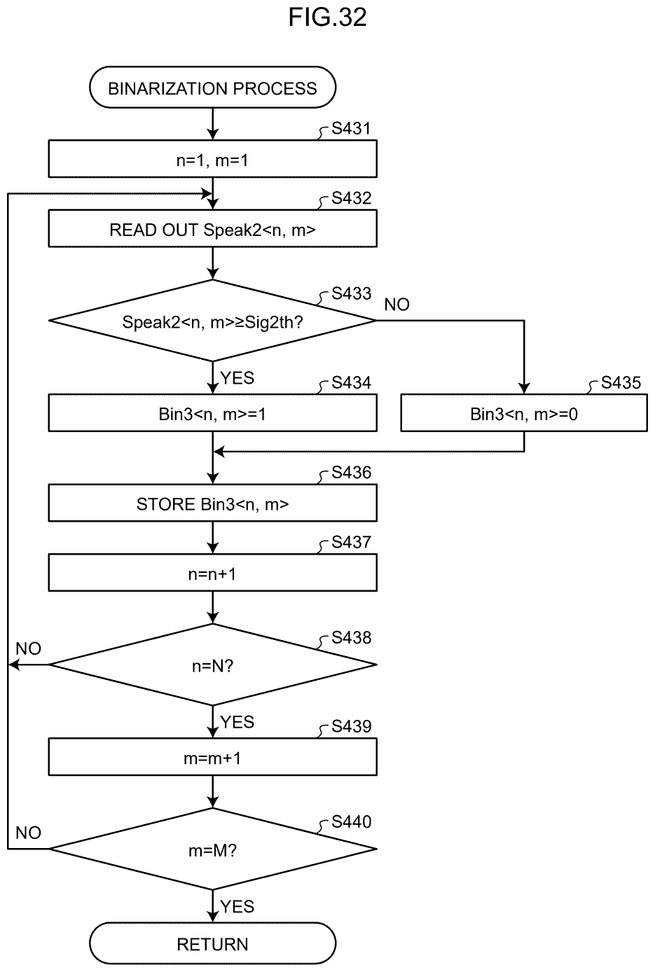

If m is greater than M (m>M) (Yes at Step S423), the process returns to the second image generation process illustrated in FIG. 28, and the signal processing circuit 44 then performs the binarization process illustrated in FIG. 32 (Step S430 in FIG. 28). FIG. 32 is a sub-flowchart illustrating an example of the binarization process in the second image generation process.

In the binarization process illustrated in FIG. 32, the signal processing circuit 44 sets n=1 and m=1 (Step S431), reads out the second signal strength Speak2<n,m> from the storage circuit 46 (Step S432), and determines whether the read out second signal strength Speak2<n,m> is equal to or higher than a predetermined threshold Sig2th (Speak2<n,m>>Sig2th) (Step S433).

If the second signal strength Speak2<n,m> is equal to or higher than the threshold Sig2th (Yes at Step S433), a third binary value Bin3<n,m> of the pixel PAA in the nth column and the mth row is set to “1” (Bin3<n,m>=1 at Step S434) and stored in the storage circuit 46 (Step S436).

If the second signal strength Speak2<n,m> is lower than the threshold Sig2th (No at Step S433), the third binary value Bin3<n,m> of the pixel PAA in the nth column and the mth row is set to “0” (Bin3<n,m>=0 at Step S435) and stored in the storage circuit 46 (Step S436).

The signal processing circuit 44 then sets n=n+1 (Step S437) and determines whether n is N (n=N) (Step S438). If n is less than N (n<N) (No at Step S438), the process returns to Step S432.

If n reaches N (n=N) (Yes at Step S438), the signal processing circuit 44 then sets m=m+1 (Step S439) and determines whether m is M (m=M) (Step S440). If m is less than M (m<M) (No at Step S440), the process returns to Step S432.

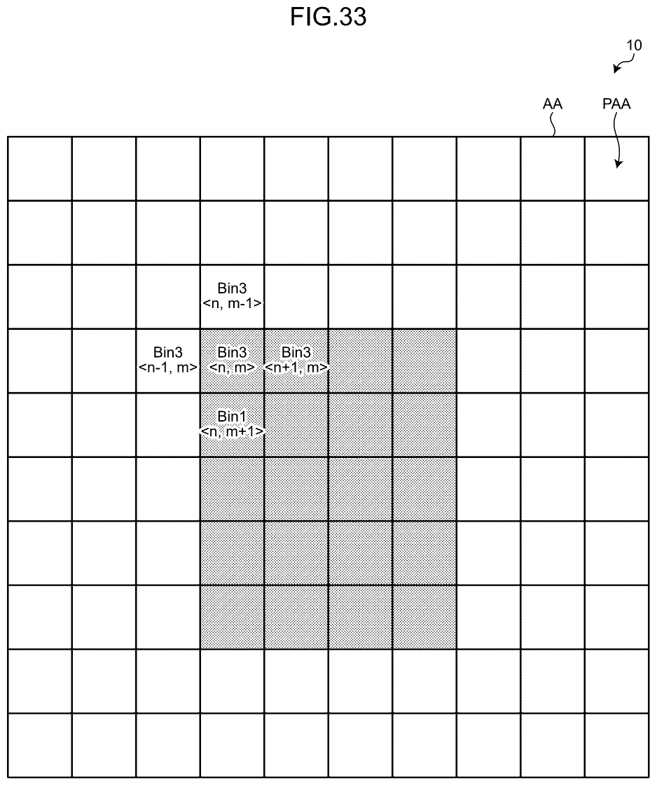

By repeating the above-described processes from Step S432 to Step S440 N×M times, the third binary value Bin3<n,m> of each of the pixels PAA is stored in the storage circuit 46. By applying the third binary value Bin3<n,m> of each of the pixels PAA to the sensor area 10, an illustrative image illustrated in FIG. 33 is generated.

FIG. 33 is a diagram illustrating a specific example of the illustrative image obtained by converting the third binary values of the respective pixels into an image. FIG. 33 illustrates the example in which third binary values Bin3<n,m>, Bin3<n+1,m>, and Bin3<n,m+1> are “1” and third binary values Bin3<n,m−1> and Bin3<n−1,m> are “0”.

In the present disclosure, “second area” is defined as an area where the third binary value Bin3 is “1” in the illustrative image illustrated in FIG. 33. In other words, the second area represents an area where the second signal strength Speak2<n,m> is equal to or higher than the threshold Sig2th in the illustrative image illustrated in FIG. 33.

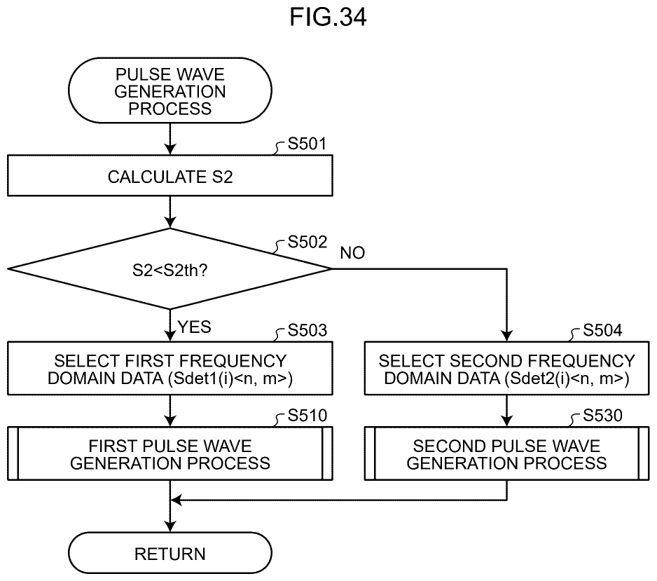

If m reaches M (m=M) (Yes at Step S440), the process returns from the second image generation process illustrated in FIG. 28 to the detection process illustrated in FIG. 13, and the signal processing circuit 44 then performs a pulse wave generation process illustrated in FIG. 34 (Step S500 in FIG. 13). FIG. 34 is a sub-flowchart illustrating an example of the pulse wave generation process.

In the pulse wave generation process illustrated in FIG. 34, the signal processing circuit 44 calculates an area S2 of the second area (refer to FIG. 33) (Step S501). The area S2 of the second area can be expressed by Expression (5) given below.

S2=ΣBin3<n,m> (5)

The signal processing circuit 44 determines whether the area S2 of the second area is smaller than a predetermined threshold S2th (S2<S2th) (Step S502).

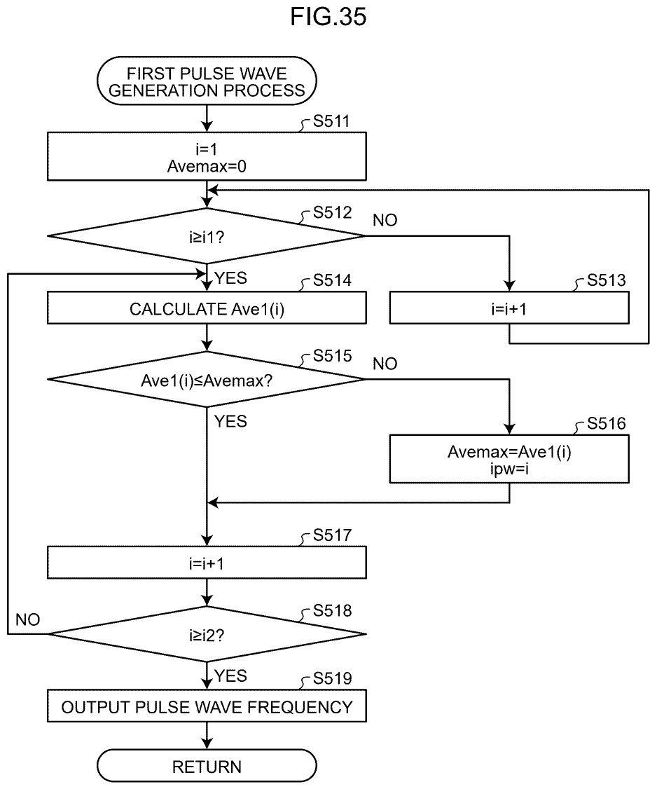

If the area S2 of the second area is smaller than the threshold S2th (Yes at Step S502), the signal processing circuit 44 selects the first frequency domain data (signal strength Sdet1(i)<n,m>) (Step S503) and performs a first pulse wave generation process (Step S510 in FIG. 34) illustrated in FIG. 35. FIG. 35 is a sub-flowchart illustrating an example of the first pulse wave generation process.

In the first pulse wave generation process illustrated in FIG. 35, the signal processing circuit 44 sets i=1 and Avemax=0 (Step S511) and determines whether the frequency line i is equal to or higher than the first frequency line i1 (Step S512). If the frequency line i is lower than the first frequency line i1 (No at Step S512), the signal processing circuit 44 increments the frequency line i by 1 (i=i+1 at Step S513) and repeats the processes at Step S512 and Step S513 until the frequency line i becomes equal to or higher than the first frequency line i1 (Yes at Step S512).

If the frequency line i becomes equal to or higher than the first frequency line i1 (Yes at Step S512), the signal processing circuit 44 calculates an average Ave1(i) for each of the frequency lines i of the first frequency domain data (signal strength Sdet1(i)<n,m>) of all the pixels PAA included in the first area (refer to FIG. 21) (Step S514). The average Ave1(i) for each of the frequency lines i can be expressed by Expression (6) given below.

Ave1(i)=ΣSdet1(i)<n,m>/ΣBin1<n,m> (6)

The signal processing circuit 44 then performs a comparative determination process between the average Ave1(i) calculated at Step S514 and Avemax. Specifically, the signal processing circuit 44 determines whether the average Ave1(i) calculated at Step S514 is equal to or less than Avemax (Step S515).

If the average Ave1(i) is equal to or less than Avemax (Yes at Step S515), the process moves to Step S517. If the average Ave1(i) exceeds Avemax (No at Step S515), the signal processing circuit 44 sets the average Ave1(i) to Avemax, and stores the frequency line i as a frequency line ipw corresponding to the pulse wave component in the storage circuit 46 (Avemax=Ave1(i) and ipw=i, at Step S516), and the process moves to Step S517.

After the process moves to Step S517, the signal processing circuit 44 increments the frequency line i by 1 (i=i+1 at Step S517) and determines whether the frequency line i is equal to or higher than the second frequency line i2 (i≥i2) (Step S518). If the frequency line i is lower than the second frequency line i2 (i<i2) (No at Step S518), the process returns to Step S514.

By repeating the above-described processes from Step S514 to Step S518, the frequency line ipw corresponding to Avemax that is the peak value of the signal strength Ave1(i) after the averaging process is stored in the storage circuit 46.

If the frequency line i becomes equal to or higher than the second frequency line i2 (i≥i2) (Yes at Step S518), a frequency corresponding to the frequency line ipw is output as a pulse wave frequency to the host, for example (Step S519). The process then returns from the pulse wave generation process illustrated in FIG. 34 to the detection process illustrated in FIG. 13, and the detection process ends.

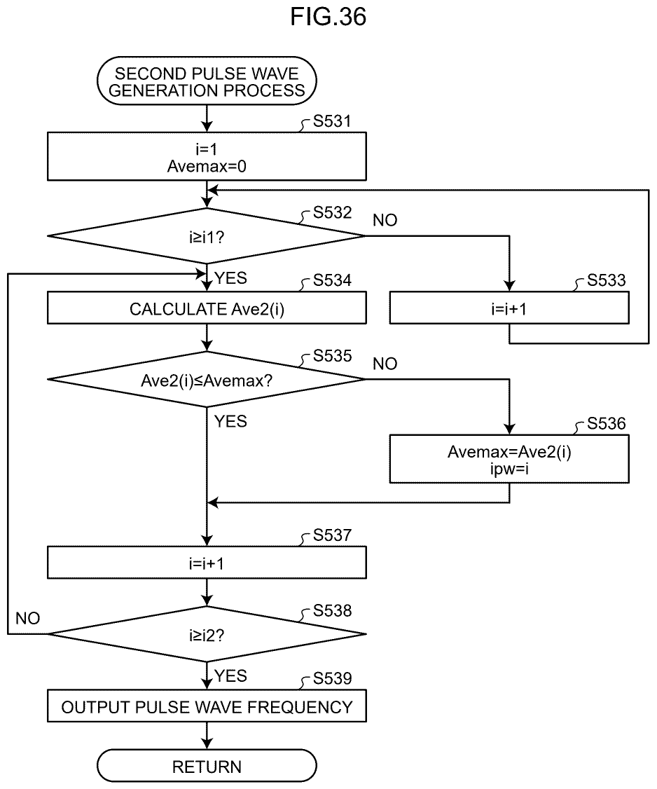

Referring back to Step S502 illustrated in FIG. 34, if the area S2 of the second area is equal to or larger than the threshold S2th (No at Step S502), the signal processing circuit 44 selects the second frequency domain data (signal strength Sdet2(i)<n,m>) (Step S504) and performs the second pulse wave generation process illustrated in FIG. 36 (Step S530 in FIG. 34). FIG. 36 is a sub-flowchart illustrating an example of the second pulse wave generation process.

In the second pulse wave generation process illustrated in FIG. 36, the signal processing circuit 44 sets i=1 and Avemax=0 (Step S531) and determines whether the frequency line i is equal to or higher than the first frequency line i1 (Step S532). If the frequency line i is lower than the first frequency line i1 (No at Step S532), the signal processing circuit 44 increments the frequency line i by 1 (i=i+1 at Step S533) and repeats the processes at Step S532 and Step S533 until the frequency line i becomes equal to or higher than the first frequency line i1 (Yes at Step S532).

If the frequency line i becomes equal to or higher than the first frequency line i1 (Yes at Step S532), the signal processing circuit 44 calculates an average Ave2(i) for each of the frequency lines i of the second frequency domain data (signal strength Sdet2(i)<n,m>) of all the pixels PAA included in the second area (refer to FIG. 33) (Step S534). The average Ave2(i) for each of the frequency lines i can be expressed by Expression (7) given below.

Ave2(i)=ΣSdet2(i)<n,m>/ΣBin3<n,m> (7)

The signal processing circuit 44 then performs the comparative determination process between the average Ave2(i) calculated at Step S534 and Avemax. Specifically, the signal processing circuit 44 determines whether the average Ave2(i) calculated at Step S534 is equal to or less than Avemax (Step S535).

If the average Ave2(i) is equal to or less than Avemax (Yes at Step S535), the process moves to Step S537. If the average Ave2(i) exceeds Avemax (No at Step S535), the signal processing circuit 44 sets the average Ave2(i) to Avemax, and stores the frequency line i as a frequency line ipw corresponding to the pulse wave component in the storage circuit 46 (Avemax=Ave2(i) and ipw=i, at Step S536), and the process moves to Step S537.

After the process moves to Step S537, the signal processing circuit 44 increments the frequency line i by 1 (i=i+1 at Step S537) and determines whether the frequency line i is equal to or higher than the second frequency line i2 (i≥i2) (Step S538). If the frequency line i is lower than the second frequency line i2 (i<i2) (No at Step S538), the process returns to Step S534.

By repeating the above-described processes from Step S534 to Step S538, the frequency line ipw corresponding to Avemax that is the peak value of the signal strength Ave2(i) after the averaging process is stored in the storage circuit 46.

If the frequency line i becomes equal to or higher than the second frequency line i2 (i≥i2) (Yes at Step S538), the frequency corresponding to the frequency line ipw is output as the pulse wave frequency to, for example, the host (Step S539). The process then returns from the pulse wave generation process illustrated in FIG. 34 to the detection process illustrated in FIG. 13, and the detection process ends.

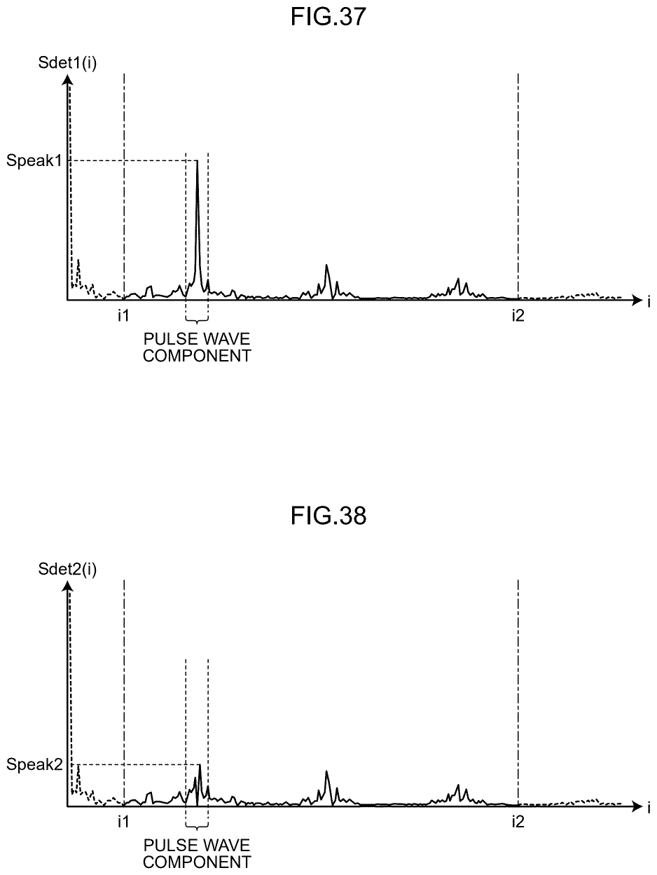

FIG. 37 is a diagram illustrating an example of the first frequency domain data when the time domain data does not contain periodic noise components such as the body motion noise. FIG. 38 is a diagram illustrating an example of the second frequency domain data when the time domain data does not contain the periodic noise components such as the body motion noise.

The examples illustrated in FIGS. 37 and 38 illustrate an example in which the pulse wave component of the first frequency domain data (signal strength Sdet1(i)<n,m>) is extracted as the first signal strength Speak1 in the first signal strength extraction process (Step S210 in FIG. 16) illustrated in FIG. 17, and as a result, the second frequency domain data (signal strength Sdet2(i)<n,m>) with reduced pulse wave components is obtained in the second signal strength calculation process illustrated in FIG. 29 (Step S410 in FIG. 28). In this case, at Step S433 of the binarization process in the second image generation process illustrated in FIG. 32, the pixels PAA where the second signal strength Speak2<n,m> is equal to or higher than the threshold Sig2th (Yes at Step S433) significantly decreases in number, resulting in the smaller area S2 of the second area (refer to FIG. 33).

In an aspect of the present disclosure, in the pulse wave generation process illustrated in FIG. 34, if the area S2 of the second area is smaller than the threshold S2th (Yes at Step S502), the signal processing circuit 44 selects the first frequency domain data (signal strength Sdet1(i)<n,m>) (Step S503) and performs the first pulse wave generation process (Step S510 in FIG. 34) illustrated in FIG. 35. As a result, the accurate pulse wave components can be obtained regardless of the presence or absence of the periodic noise components such as the body motion noise.

The processing described above can reduce the periodic body motion noise when acquiring the biometric information.

In the embodiment described above, the example of acquiring the pulse waves as the biometric information has been described, but the scope of application of the detection device 1 according to the present disclosure is not limited to the pulse wave frequency. The detection device 1 according to the present disclosure is widely applicable to configurations for acquiring the biometric information on the subject person that varies periodically.

While the preferred embodiment of the present disclosure has been described above, the present disclosure is not limited to such an embodiment. The content disclosed in the embodiment is merely an example, and can be variously modified within the scope not departing from the gist of the present disclosure. Any modifications appropriately made within the scope not departing from the gist of the present disclosure also naturally belong to the technical scope of the present disclosure. At least one of various omissions, substitutions, and changes of the components can be made without departing from the gist of the embodiment described above and the modifications thereof.

What is claimed is:

1. A detection device comprising:
a sensor area comprising a plurality of pixels arranged in a planar configuration;
a light source configured to emit light to the sensor area; and
a detection circuit configured to acquire periodically varying biometric information based on data acquired from the sensor area, wherein
the detection circuit is configured to:
generate first frequency domain data for each of the pixels by converting detection values of the pixel acquired in chronological order into signal strengths for respective frequencies;
set a highest strength of the signal strengths corresponding to the respective frequencies of the first frequency domain data, as a first signal strength of each of the pixels;
set an area in the sensor area where the first signal strength is equal to or higher than a predetermined value, as a first area;
generate second frequency domain data in which a predetermined frequency range of the first frequency domain data of all the pixels in the first area is masked, based on the first frequency domain data of the pixels at an outer periphery of the first area;
set a highest strength of the signal strengths corresponding to the respective frequencies of the second frequency domain data, as a second signal strength of each of the pixels;
set an area in the sensor area where the second signal strength is equal to or higher than the predetermined value, as a second area;
acquire the biometric information based on the second frequency domain data when a size of the second area is equal to or larger than a predetermined value; and
acquire the biometric information based on the first frequency domain data when the size of the second area is smaller than the predetermined value.

2. The detection device according to claim 1, wherein
the detection circuit is configured to:
perform an averaging process on the signal strengths for respective frequencies of the first frequency domain data of the pixels at the outer periphery of the first area, and generate a filter to mask a predetermined range that includes a frequency at which the signal strength is maximized, of the respective frequencies of the frequency domain data after the averaging process, and
generate the second frequency domain data by applying the filter to the first frequency domain data for each of all the pixels in the first area.

3. The detection device according to claim 2, wherein
the detection circuit is configured to:
when generating the filter, set a filter value of a frequency at which the signal strength after the averaging process is equal to or higher than a predetermined threshold to 0, and a filter value of a frequency at which the signal strength after the averaging process is lower than the predetermined threshold to 1, and
generate the second frequency domain data by multiplying a signal strength of the first frequency domain data by a filter value corresponding to each frequency.

4. The detection device according to claim 1, wherein the detection circuit is configured to perform an averaging process on the signal strengths of the second frequency domain data of the pixels included in the second area, and acquire a frequency corresponding to a peak value of the signal strength after the averaging process as the biometric information, when the size of the second area is equal to or larger than the predetermined value.

5. The detection device according to claim 1, wherein the detection circuit is configured to perform an averaging process on the signal strengths of the first frequency domain data of the pixels included in the first area, and acquire a frequency corresponding to a peak value of the signal strength after the averaging process as the biometric information, when the size of the second area is smaller than the predetermined value.

6. The detection device according to claim 1, wherein the detection circuit is configured to limit a frequency range in acquisition of the biometric information to a range equal to or higher than 0.5 Hz and lower than 4 Hz.

7. The detection device according to claim 1, wherein
the pixels are each provided with an optical sensor, and
the optical sensor is an organic photodiode, and comprises:
an active layer;
an upper electrode provided with an upper buffer layer interposed between the upper electrode and the active layer; and
a lower electrode provided with a lower buffer layer interposed between the lower electrode and the active layer.

8. The detection device according to claim 1, wherein the light source comprises at least a first light source configured to emit first light to the sensor area.

9. The detection device according to claim 8, wherein the first light is red light or infrared light.

10. The detection device according to claim 8, wherein the first light is blue light or green light.

11. The detection device according to claim 1, wherein
the light source comprises:
a first light source configured to emit first light to the sensor area, and
a second light source configured to emit second light to the sensor area.

12. The detection device according to claim 11, wherein
the first light is red light, and
the second light is infrared light.

13. A wearable device comprising the detection device according to claim 1, wherein the wearable device has a ring shape wearable on a human body.

14. The wearable device according to claim 13, configured to be worn on a finger or a thumb of the human body.

15. The wearable device according to claim 13, configured to be worn on a wrist or an arm of the human body.

16. The wearable device according to claim 13, configured to be worn on a leg of the human body.
